(19) United States
(12) Patent Application Publication
(10) Pub. No.: US 2020/0370696 A1
(43) Pub. Date: Nov. 26, 2020

(54) Line Connector

(71) Applicant: NORMA Germany GmbH, Maintal (DE)

(72) Inventor: Bote Zhang, Qingdao City, Shandong (CN)

(21) Appl. No.: 16/768,185

(22) PCT Filed: Oct. 29, 2018
(86) PCT No.: PCT/EP2018/079579

§ 371 Date: May 29, 2020

(30) Foreign Application Priority Data
Nov. 29, 2017 (CN) 201711222288.7

(51) Int. Cl. F16L 37/098; F16L 37/14

(52) U.S. Cl. CPC F16L 37/0987; F16L 37/144; F16L 2201/10; F16L 2201/60; F16L 2201/20; F16L 37/0982

(57) ABSTRACT

The disclosure relates to a line connector that can be switched from a locking to an unlocking position solely by means of application of a linear force to a conduit (K) along an engagement axis (E). This solves the problem of how to operate such a line connector using only one hand. The connector has a mechanism configured so as to allow a cam body connected to the conduit (K) to occupy, at different rotational positions of the cam body, an unlocking position in which an attachment mechanism for the conduit (K) can be unlocked, and a locking position in which the attachment mechanism cannot be unlocked.

### TECHNICAL FIELD

The disclosure relates to the field of fluid connectors, and in particular, to a line connector.

### BACKGROUND

Line connectors are typically used to connect a conduit, in particular the spigot of a conduit, to a desired location, for instance to a fluid line. Line connectors have an inlet for the spigot and an outlet, for example with a fir-tree geometry.

Prior art connectors can be quite complicated to use, especially if a locking and unlocking mechanism are to be included. Such connectors are typically utilized in regions of machines or vehicles where space is tight, and in order to operate the line connector (for example, to unlock it), it has been necessary for a user to reach down into this tight space and attempt to actuate the unlocking mechanism. This usually involves pressing and holding certain parts of the line connector whilst also pulling on the spigot, which can be difficult to coordinate, especially when working inside a vehicle, for example.

Ideally, it would be possible to engage and disengage, or lock and unlock, the connector in a simpler manner. In particular, in a way which did not require a user to operate a complicated mechanism in a tight space or to press certain parts of the line connector at the same time as pulling on others. A connector that would allow an operator to hold any part of it when actuating an unlocking or locking mechanism would be a large step forward in the art.

Not only would this make the line connector easier to use overall, but the provision of a simpler mechanism may also mean that manufacturers would not need to provide as much space in the area where the connector is to be utilized. This would be advantageous in modern cars, for example, where space is at a premium and component assembly is more complicated.

### SUMMARY

The present disclosure, per an embodiment, is therefore directed to providing simpler line connector that can be operated without having to push and pull on different parts of the connector at the same time and which is otherwise particularly simple to use. The line connector should at the same time have an effective and secure engagement or locking mechanism, which is able to securely engage or lock a spigot in the line connector. Such a connector should also, where possible, be simple and cost-effective in its manufacture.

In accordance with one embodiment of the disclosure, there is provided a line connector having a housing with an inlet for a spigot of a conduit and an outlet, the line connector having an engagement mechanism for releasably holding the spigot in an inserted position, the engagement mechanism surrounding an engagement axis. The engagement mechanism comprises: a conversion mechanism, and configured to be moveable relative to the conversion mechanism along and around the engagement axis and comprising an attachment mechanism for the conduit, whereby the conversion mechanism and the cam body are configured such that through engagement of the cam body with the conversion mechanism, motion of the cam body along the engagement axis is converted into rotational motion of the cam body around the engagement axis, whereby the conversion mechanism is further configured so as to allow the cam body to occupy, at different rotational positions of the cam body, an unlocking position in which the attachment mechanism can be unlocked for releasing the spigot from the line connector, and a locking position in which the attachment mechanism is locked.

Other embodiments of the line connector may have the following additional features, either individually or in any technically feasible combination.

The conversion mechanism comprises a first operational element and a second operational element which may be fixed relative to movement along and around the engagement axis, and whereby the cam body is arranged to be moveable along and around the engagement axis between the first operational element and the second operational element.

The second operational element and the cam body are configured such that through engagement of the cam body with the second operational element, linear motion of the cam body along the engagement axis is converted into rotational motion of the cam body around the engagement axis, whereby the first operational element is configured so as to allow the cam body to occupy, at different rotational positions of the cam body, an unlocking position in which the attachment mechanism can be unlocked, and a locking position in which the attachment mechanism is locked.

The first operational element and the cam body are configured such that through engagement of the cam body with the first operational element, linear motion of the cam body along the engagement axis is converted to rotational motion of the cam body around the engagement axis.

The unlocking and locking positions respectively comprise a protracted position and a retracted position of the cam body along the engagement axis.

The line connector is configured such that in the unlocking position, the attachment mechanism can be opened through application of a force to the cam body along the engagement axis, preferably in a removal direction of an inserted spigot.

The attachment mechanism can be opened by forcing the cam body and the first operational element together, whereby the first operational element is arranged further towards an insertion opening for the spigot than the second operational element.

The locking position, the attachment mechanism is prevented from opening by a cooperation between the cam body and the first operational element, whereby the first operational element is arranged further towards an insertion opening for the spigot than the second operational element.

The attachment mechanism comprises at least one hook part.

The line connector is configured such that the attachment mechanism can be opened through movement of the at least one hook part, preferably in the radially outward direction.

The line connector is configured to hinder movement, in particular radially outward movement, of the at least one hook part in the locking position.

The first operational element comprises a space into which the at least one hook part may be displaced in the unlocking position.

The at least one hook part comprises at least one inclined region.

The cam body comprises at least one inclined region configured and located so that a protrusion on an outer surface of an inserted spigot may bear against the at least one inclined region when the spigot is removed from the line connector.

The cam body comprises at least one inclined region configured and located so that a protrusion on an outer surface of the spigot to be inserted may bear against the at least one inclined region when the spigot is inserted into the line connector.

The cam body comprises an abutment for actuating the attachment mechanism and configured to bear against the first operational element when the cam body is forced against the first operational element.

In a line connector having a housing with an inlet for a spigot of a conduit and an outlet, the line connector having an engagement mechanism for releasably holding the spigot in an inserted position, the engagement mechanism surrounding an engagement axis, the disclosure, per an embodiment, resides in that the engagement mechanism comprises: a conversion mechanism, and a cam body configured to be moveable relative to the conversion mechanism along and around the engagement axis and comprising an attachment mechanism for the conduit, whereby the conversion mechanism and the cam body are configured such that through engagement of the cam body with the conversion mechanism, motion of the cam body along the engagement axis is converted into rotational motion of the cam body around the engagement axis, whereby the engagement mechanism is further configured so as to allow the cam body to occupy, at different rotational positions of the cam body, an unlocking position in which the attachment mechanism can be unlocked for releasing the spigot from the line connector, and a locking position in which the attachment mechanism is locked.

In such a line connector, an aspect according to an embodiment is the presence of the conversion mechanism, which allows linear motion of the conduit, in particular its spigot, to create rotational motion of the cam body, which is attached to the spigot. Since the engagement mechanism is configured to allow the cam body to occupy an unlocking position and a locking position at different rotational positions of the cam body, it is possible to lock and unlock the attachment mechanism simply by providing linear motion of the spigot, to which the cam body is attached. Since simple linear motion of a single part does not require the use of two hands, it may thus be seen how the line connector may be locked and unlocked using only one hand. For instance, a line connector may be placed in its desired position (e.g. fixed to an attachment point), and a conduit may simply be pushed into the line connector and moved linearly in order to actuate the engagement mechanism.

The cam body has two functions, per an embodiment. A first is to act to attach a spigot within the line connector. The ability to cause attachment between the cam body and the spigot is important in this embodiment because otherwise it might be possible to simply pull the spigot out of the line connector. A second purpose is to act as a lock in cooperation with the conversion mechanism, so that it is only possible to remove the spigot in certain positions. In the present disclosure, these positions are reached through rotation of the cam body.

Preferably, per an embodiment, the cam body is able to rotate around the body of the conduit to ensure that the conduit is not twisted when the cam body is rotated in order to enter locking and unlocking positions. Twisting of the conduit itself would be disadvantageous, since this could result in the conduit not permitting the passage of liquid. Although it may be understood that a small amount of twist would probably not result in blockage of the conduit, a mechanism where the conduit itself rotates is not the focus of the present application. For this purpose, the attachment mechanism may be configured to allow the cam body to rotate about the conduit.

The conversion mechanism may be embodied in several ways and embodiments. One embodiment discovered by the inventor is to use inclined portions or sloped regions positioned within the line connector so that motion of the cam body against them causes the cam body to rotate. In this way, when the cam body moves linearly and comes into contact with a sloped surface, the sloped surface may act as a wedge to change the direction of movement of the cam body, in other words to impart a component of movement perpendicular to the direction of linear motion. In this way, it is possible that the cam body is rotated by an amount when it is driven into contact with a sloping region. Other conceivable embodiments might entail using linear motion to unravel a coiled spring (which would impart rotational motion). Other examples could include a threaded screw-like portion, or a system of bevel gears, or a rack-and-pinion type system. The skilled person may be familiar with other mechanisms that may be used to achieve the required effect of converting linear motion into rotational motion.

The provision of locking and unlocking positions by the engagement mechanism also has several means of implementation. A favourable way found by the inventor, according to an embodiment, is to provide that in one rotational position, the attachment mechanism of the cam body is free to open and close, whereas in another rotational position, the attachment mechanism is blocked from opening by an element of the conversion mechanism. However, it is also conceivable that this could be achieved by having a protrusion of the cam body mate with a recess in the housing in one rotational (locking) position, whereby in an unlocking position, there is no engagement. The skilled person may also be familiar with other suitable locking mechanisms.

The conversion mechanism may be fixed to the housing such that rotational movement and movement along the engagement axis thereof is prevented. For embodiments where sloping regions are employed, this increases the effectiveness of the mechanism by ensuring that the cam body can bear against the conversion mechanism in order to rotate. If the conversion mechanism were able to move either rotationally around or longitudinally along the engagement axis, then linear motion of the conduit might cause only linear motion of the conversion mechanism, and not linear motion of the cam body resulting in rotational motion of the cam body. Fixing may be achieved by typical snap-in connections, adhesives or force connections, for example.

The attachment mechanism should, according to an embodiment, secure the conduit tightly relative to linear movement against the cam body, in order that the engagement mechanism is able to operate effectively as possible (in particular so that linear motion of the conduit is translated effectively to linear motion of the cam body).

In an embodiment of the disclosure, the conversion mechanism comprises a first operational element and a second operational element, whereby the first operational element and the second operational element may be fixed relative to movement along and around the engagement axis, and whereby the cam body is arranged to be moveable along the engagement axis between the first operational element and the second operational element. In this embodiment, unlocking and locking may be achieved by a simple back and forth motion of the cam body (and thus the conduit), since the cam body is arranged between the first and second operational elements of the conversion mechanism.

In a further example, the second operational element and the cam body are configured such that through engagement of the cam body with the second operational element, linear motion of the cam body along the engagement axis is converted into rotational motion of the cam body, whereby the first operational element is configured so as to allow the cam body to occupy, at different rotational positions of the cam body, an unlocking position in which the attachment mechanism can be unlocked, and a locking position in which the attachment mechanism cannot be unlocked.

This embodiment may allow a forward linear motion to take the cam body out of a locking position, the forward linear motion also effecting rotational motion of the cam body by engagement with the second operational element, followed by subsequent backward linear motion of the conduit and cam body, where the cam body is brought into an unlocking position without being rotated further by the first operational element. Thus, the cam body has to undergo reduced rotational motion in order to reach the locking or unlocking position, reducing the time to reach different engagement positions and reducing wear.

In an embodiment, the first operational element and the cam body are configured such that through engagement of the cam body with the first operational element, linear motion of the cam body along the engagement axis is converted to rotational motion of the cam body. Here, it may be the case that a forward linear motion occurs to take the cam body out of a locking position, the forward linear motion also effecting rotational motion of the cam body by engagement with the second operational element, followed by subsequent backward linear motion of the conduit and cam body, which may cause the cam body to further rotate into an unlocking position via further engagement with the first operational element. This additional rotational motion may be useful if the implementation of the conversion mechanism chosen requires less force to operate (such as slopes of steeper gradient), which may come at the expense of the amount of rotation that it is able to cause. Thus, it may be necessary, per an embodiment, to cause further rotation in order through the second operational element so that the cam body reaches the required position.

According to an embodiment, the unlocking and locking positions respectively comprise a protracted position and a retracted position of the cam body along the engagement axis. The protracted position may be further into the housing and the retracted position may be further out of the housing. This ensures that the respective positions are clearly separated from one another, which reduces the chance that application of too great a force might cause the cam body to accidentally slip from a locked position to an unlocked position, or vice versa. It also allows a user to recognise from the position of the conduit whether the line connector is in a locking state or not, for instance from the position of markings on the conduit relative to the line connector.

An embodiment provides that the line connector is configured such that in the unlocking position, the attachment mechanism can be opened through application of a force to the cam body along the engagement axis, preferably in a removal direction of an inserted conduit. Thus, it is not the case that in the unlocking position, the conduit can simply fall out of the connector. Rather, the attachment mechanism is such that the conduit is retained until a user actively pulls the conduit out of the connector. Furthermore, since the cam body is attached to the conduit, the conduit itself, rather than other parts or tools, can be directly used to open the attachment mechanism.

In a further embodiment, the attachment mechanism may be opened by forcing the cam body and the first operational element together, whereby the first operational element is arranged further towards a conduit insertion opening than the second operational element. This essentially has the effect that in order to open the attachment mechanism, the conduit would be pulled against the first operational element in the direction of removal of the conduit, which means that the same force and motion used to open the attachment mechanism may also be used to remove the conduit from the line connector.

Per an embodiment, in the locking position, the attachment mechanism is prevented from opening by a cooperation between the cam body and the first operational element, whereby the first operational element is arranged further towards a conduit insertion opening than the second operational element. One advantageous aspect, according to an embodiment, is that it could be easier to machine the first operational element appropriately to enable the said cooperation, in contrast to machining the internal regions of the housing, which may be more difficult to access. Such a cooperation may be, for example, that the first operational element surrounds the attachment mechanism to prevent it from opening, or that a snap-in element on the cam body engage with a snap-in element on the first operational element.

However it is also thinkable that in the locking position, the attachment mechanism is prevented from opening by a cooperation between the cam body and the housing. For instance, it may be that in one rotational position, the cam body and the housing mate together via an interlock mechanism such that the cam body cannot be opened. In another rotational position, the cam body may be free of such an interlock mechanism so that the attachment mechanism can be opened. This mechanism could be suitable in situations where greater forces are applied to the conduit, because the housing is generally thicker and larger than any inserted parts and thus may support greater forces being applied to the attachment mechanism in the locking position.

Ideally, the attachment mechanism is an interlock mechanism. Such mechanisms are effective and easily releasable, in contrast to an adhesive mechanism, for instance. One example of a design is where the attachment mechanism comprises at least one hook part.

In one aspect, per an embodiment, the line connector is configured such that the attachment mechanism can be opened through movement of the at least one hook part, preferably in the radially outward direction. Movement of the hook part may be simple to effect through motion of the cam body. Further, there is more space in the radially outward direction than in the radially inward direction or in the axial direction, where the conduit itself is located.

In an embodiment, the line connector, e.g. the first operational element, is configured to hinder movement, in particular radially outward movement, of the at least one hook part in the locking position. In this way, the line connector or the first operational element can act as a passive locking means.

This may be achieved, per an embodiment, in that the first operational element comprises an inner wall which blocks the hook part of the attachment mechanism from opening sufficiently in the locking position. In this way, the at least one hook part is enclosed by an inner region of the first operational element. The inner profile of the wall in this region may substantially or completely match the outer profile of the hook part.

In another example, the first operational element comprises a space into which the at least one hook part may be displaced in the unlocking position. In this way, the unlocking position may be created simply solely by removal of a section of material, which is not difficult to carry out using commonly available tools. This space may be an inner recess formed in an inner wall of the first operational element. Per an embodiment, a space is provided for each hook part. Per an embodiment, such a space does not exist in the locking position.

In order to minimize the presence of edges and sharp surfaces which could promote wear when the various parts are moved relative to each other, the at least one hook part comprises at least one inclined region.

In an embodiment, the cam body, e.g. the hook part, comprises at least one inclined region configured and located so that a protrusion on an outer surface of an inserted conduit may bear against the at least one inclined region when the conduit is removed from the line connector. This not only reduces the effects of wear, but also provides an effective way of creating radial movement of the hook part to open the attachment mechanism to enable removal of the conduit, through axial movement of the conduit along the engagement axis. In other words, the at least one inclined region may be provided in an attachment region of the cam body, for example in an inner region.

It is a further advantage, per an embodiment, if the cam body, e.g. the hook part, comprises at least one inclined region configured and located so that a protrusion on an outer surface of a conduit to be inserted may bear against it when the conduit is inserted into the line connector. This not only reduces the effects of wear, but also provides an effective way of creating radial movement of the leg to open the attachment mechanism for insertion of a conduit, through axial movement of the conduit along the engagement axis. In other words, the at least one inclined region may be formed at an outer surface of the cam body, preferably at a front side of the cam body.

In a further example, the cam body comprises an abutment for actuating the attachment mechanism and configured to bear against the first operational element when the cam body is forced against the first operational element, e.g. along the engagement axis. A dedicated abutment appropriately positioned may produce a very effective opening force by essentially acting as a lever. This may reduce the pulling force that must be applied in order to remove the conduit from the unlocking position. The abutment may be a protrusion, and where the term protrusion is used in this application, it shall also be understood to encompass the possibility of an abutment where technically feasible. The abutment ideally extends perpendicular to the direction of removal of the conduit (in other words, perpendicular to the engagement axis), so that the force moment is maximized. In addition, the force applied will be greater the further the abutment extends. For this reason, it may be of benefit if the abutment extends at least halfway to the wall of the housing, preferably at least three quarters of the way, and preferably per an embodiment at least all the wall to the wall of the housing (it being understood that an insignificant gap would be left between the abutment and the housing so that movement of the cam body is not hindered).

According to an embodiment, the attachment mechanism comprises a recess arranged at an inner region of the cam body. This may be suitable to function as part of an interlock mechanism for securing the cam body in the locking position. This may provide an appropriate accommodation for a corresponding protrusion on a conduit, in order to secure the conduit to the cam body. The recess is a circumferential recess, in an embodiment, so that rotation of the cam body around the conduit is not hindered and further so that the conduit may be secured around its entire circumference. This ensures that force is applied evenly and reduces the likelihood or severity of component stress.

Sloping Regions

In this application, some embodiments of the conversion mechanism make use of sloping regions, as previously alluded to. The following is a general discussion of aspects of the sloping regions, the subject matter of which may apply to all cases and parts that make use or may make use of sloping regions. In particular, this may include the conversion mechanism, the first operational element, and the second operational element, but also the housing and the cam body in other embodiments.

The terms “first sloping region(s)” and “second sloping region(s)” are understood to mean those sloping regions contacted by the cam body for the purposes of causing rotational motion thereof via linear motion along the engagement access. It is conceivable that other sloping regions are present which do not make a technical contribution to this specific purpose. These regions are not intended to be encompassed by the terms “first sloping region(s)” and “second sloping region(s)”. Further, the term “sloping region” may also mean “sloping surface”.

The term slope is used to describe a change in surface gradient, which may be linear or non-linear, or constant or non-constant. In particular, slopes do not have to be formed by inclined plane surfaces but may also be formed by curved surfaces. Where the terms “clockwise” or “counter clockwise” are used, this may, but does not necessarily have to, imply the shape of a circle. Instead, it may also simply mean any path of clockwise or counter clockwise movement, for instance in the shape of a square or rectangle.

The slope gradient may be chosen depending on how far the cam body should rotate or how much force should be necessary to cause rotation. In an embodiment, when the acute angle formed by the slope with respect to the engagement axis is small, for instance, between 5 and 15 degrees, the component or amount of rotation will be relatively small when compared to linear motion. At the other extreme, when the acute angle formed by the slope with respect to the engagement axis is large, for instance, 85 to 70 degrees, the component or amount of rotation will be relatively large. In the latter case, the force needed to created rotational motion will be considerably larger than in the former case, where the force will be much smaller but at the expense of less rotation. According to an embodiment, the inventors have discovered that an acute angle in the region of 60 to 80 degrees with respect to the engagement axis is most preferable.

It is also to be understood that the direction of rotation is determined by the direction of slope around the engagement axis. In other words, clockwise rotation may be produced when the slope has a component of downward slope in a clockwise direction.

Preferably, per an embodiment, the second operational element comprises second sloping regions. This means that rotation of the cam body can be achieved when the cam body and conduit is pushed against the second operational element.

Per an embodiment still, the first operational element comprises first sloping regions and the second operational element comprises second sloping regions. In this way, rotation of the cam body is caused when the cam body is pressed by the conduit against the first operational element and the second operational element.

Ideally, per an embodiment, the orientation of sloping regions corresponds to the path followed by the part of the cam body that contacts those sloping regions (e.g. in the case of a circular path, the sloping regions will follow a circular path). Ideally, per an embodiment, the first sloping regions slope in the same direction along the engagement axis and the second sloping regions slope in the same direction along the engagement axis.

Preferable, per an embodiment, is that the first sloping regions have a clockwise decline when viewing the top side of the first operational element and that the second sloping regions have a counter clockwise decline when viewing the top side of the second operational element. Naturally, first sloping regions may also be counter clockwise and the second sloping regions clockwise in this embodiment. This ensures that the cam body always rotates in the same direction, rather than rotating back and forth between two different positions, although in some situations this may also be desired. This arrangement may apply when the first and second operational elements are present in the housing.

Preferably, per an embodiment, the conversion mechanism (which may comprise a first operational element and/or the second operational element) and the cam body are arranged and configured such that motion of the cam body along the engagement axis can always be converted into rotational motion of the cam body around the engagement axis by the conversion mechanism (i.e. by either the first operational element or the second operational element, or both). In other words, the first operational element and second operational element may be configured such that it is not possible for the cam body to be in a position, through normal operation of the line connector, where linear motion towards the first or second operational elements would result in the cam body being in a position where there is no slope present or there are only stops present, such that rotational motion cannot actuated. Otherwise, a user may have to intervene manually.

To achieve this, sloping regions may be staggered with respect to each other around the engagement axis, in the case where both first and second operational element comprise sloping regions. In the case where only the second operational element comprises sloping regions and the first element comprises slots and/or stops, the sloping regions should be staggered with respect to the stops and/or slots.

The Cam Body

This section describes embodiments, configurations and constructions of and related to the cam body.

The cam body may have a back side (arranged to point into the housing when the cam body is in the housing), a front side (arranged opposite the back side), a (radially) outer side and a (radially) inner side.

The cam body may comprise a foundation, which acts as a central part to which other parts are attached and from which these parts stem from. The foundation is arranged at the back side of the cam body in some embodiments. The foundation may theoretically have any shape, but the present inventor has found a ring shape to be suitable. A ring may be easily machined and also has the advantage, for instance, that a conduit may be accommodated securely through its centre.

The cam body comprises an attachment mechanism for a conduit. The attachment mechanism may comprise, for example, at least one leg, which may form part of a snap-in or shaped connection. Where the attachment mechanism comprises a plurality of legs, these may be arranged at equal distances from each other around the foundation. The inventors have found that four legs may be suitable, although other numbers are of course possible.

The at least one leg may be joined to the foundation via a snap-in connection, via an adhesive, or it may be formed as one piece with the foundation, for example.

In some embodiments, the at least one leg has a recess, used to accommodate a protrusion on the outer surface of a conduit to be inserted. The at least one leg may also comprise a hook part, used to hook a conduit to be inserted to secure it. In an example, the cam body is configured to be rotatable about a conduit to be inserted, which prevents unnecessary torsion of said conduit. This may be achieved in some examples in that the cam body comprises an internal, circumferential recess, which extends a substantial way around the inner circumference (preferably all the way around) of the cam body. In the case where the cam body has a plurality of legs, each leg may have a recess forming part of said circumferential recess

The attachment mechanism may be configured to flex in order to open, for example in a radially outwards direction, or in the direction substantially perpendicular to a central axis of the cam body. Therefore, an end of the cam body in the direction of the central axis, preferably the first end, in the region of the attachment mechanism, is split in the circumferential direction for allowing the attachment mechanism to open radially outwards.

In an embodiment, the at least one leg comprises a recess and/or a hook part and may be configured to flex radially outwards. Preferably, per an embodiment, this flexion occurs from the point at which the leg is joined to the foundation. However, the entire leg may also be configured to flex.

The attachment mechanism, for instance the at least one leg, may comprise at least one inclined region. This inclined region may function to mitigate the effects of wear when the conduit is inserted or removed from the attachment mechanism. It also serves to more easily facilitate radially outward flexion of the attachment mechanism to open the mechanism for conduit insertion or removal. The at least one leg may comprise inner or outer inclined surfaces in the region of its hook part, e.g. facing into or out of the cam body. Preferably, per an embodiment, said inclined surfaces extend over the entire leg for each leg in the circumferential direction, so that it does not matter where the conduit is inserted or pulled out.

The hook part of the leg may have a bend that has one function of hooking a conduit into the attachment mechanism, for instance to prevent the conduit from being pulled out of the attachment mechanism. The hook part of the leg may also have a throat region which is substantially parallel to the central axis. Alternatively, per an embodiment, the throat region may have a slight incline relative to the central axis, so that after a conduit is inserted into the attachment mechanism, the incline bears against the conduit to urge the conduit further into the attachment mechanism. This bearing force may be provided by the at least one leg flexing back into its non-flexed position after insertion of the conduit.

The attachment mechanism may be comprised in the region of the at least one leg at the front side. Alternatively, it may be comprised in a middle region of the at least one leg between the front side and the back side. In embodiments where the attachment mechanism flexes radially outwards, greater movement is usually achieved at the end further from the point of flexion, making the attachment mechanism easier to open. Alternatively, at distances further towards the middle of the leg, more force is required to make the attachment mechanism flex further, making the attachment mechanism more secure in this region. Depending on attachment requirements, different positions may be chosen.

The at least one leg may be joined to the foundation by a joining piece, which extends along a central axis of the cam body. This piece increases the axial extension of the leg and may enable increased distance of flexion in the radial direction. The at least one leg may also comprise a radially extending part, one function of which may be to provide an abuttal region for a protrusion of an attached conduit to prevent said conduit from moving out of the attachment mechanism. A further function may be to displace a part of the leg further radially outwards so that a hook part of the leg has increased space to hook back in the radially inward direction, thereby increasing the security of the connection.

The legs may comprise one or more flanks arranged on internal sides—that is, sides of the leg in the circumferential direction. The flanks may also extend circumferentially and may extend that area of the leg that contacts the conduit, to provide further security. In particular, the flanks may extend the hook part of the leg or the recess of the leg in the circumferential direction. If the flanks only extend this particular region, material costs and weight may be saved and the ability of the attachment mechanism to open may be improved. Preferably, per an embodiment, each leg comprises two flanks arranged on opposite internal sides of the leg. The flanks may thereby lend one or more legs a substantially T-shaped profile when viewing the legs along the radial direction.

A top surface of at least one leg may comprise a lip, which extends radially further outwards than the leg. The at least one lip may act as a safety measure to prevent the cam body being pulled out of the housing when subjected to high forces, for instance high external forces or high pressure from inside the line connector. Preferably, per an embodiment, the lip extends across the entire leg in the circumferential direction. The lip may be formed to extend in the radial direction past a stop formed in the first operational element, for instance a flange, in order to prevent the cam body from being pulled out of the first operational element.

An inner surface of the cam body that receives the conduit is, per an embodiment, preferably smooth, i.e. does not comprise any bumps or uneven areas. Preferably, per an embodiment, the legs are able to flex reversibly or elastically, in particular radially outwardly and inwardly, via the joining piece. The joining piece may be formed of a polymer.

In one embodiment, the cam body has at least one protrusion arranged to engage a first operational element. Preferably, per an embodiment, the at least one protrusion is arranged on a radially outer surface of the cam body. By providing the protrusion on a radially outer surface, the protrusion is arranged at a greater distance from the radial centre of the cam body, which in turn ensures that a force moment produced will be larger and more able to rotate the entire cam body.

Of benefit is when the cam body has two such protrusions arranged opposite to each other. This ensures that the cam body bears evenly against a first operational element.

The at least one protrusion may have a particular profile to ensure that a contact between the protrusion and a first engagement profile of the first operational element is most effective and that wear is reduced. In particular, per an embodiment, the protrusion may have a region which has the same profile or configuration as a region to be contacted on the first operational element. In cases, this may be a region of incline which has the same degree of incline as the degree of incline found on first sloping regions of the first engagement profile.

The same at least one protrusion may also be configured to engage a safety latch, in particular a protrusion thereof, as described later.

It may be advantageous, per an embodiment, if the at least one protrusion of the cam body comprises a profile which has the same profile or configuration as a stop to be contacted on the first operational element. In particular, a side of the at least one protrusion may extend parallel to the central axis about which the cam body rotates, so that a stop force is provided exactly perpendicular to the direction of rotational motion. A stop side of the protrusion may also be formed so as to maximize the contact area between the stop side and the stop. Depending on the requirements of the engagement strength, the stop side may also be formed with an incline that extends in the same direction as the slope of the first operational element. If a looser fit is required, the stop side may be formed with an incline that extends in the opposite direction as the slope of the first operational element.

It is of further benefit, per an embodiment, if the cam body comprises at least one prong for engaging the second operational element, in particular the second engagement surface thereof, and preferably second sloping regions thereof. Thereby dedicated components are provided in order to actuate rotational motion.

In an embodiment, the at least one prong is arranged to extend along the central axis past the foundation, and thereby also along an engagement axis of the line connector. The extension along the engagement axis itself reduces the distance that the cam body has to travel in order for rotational motion to begin, since the prong itself has to cover less distance before it comes into contact with the second operational element. Another benefit is provided when the prong extension occurs from a radially outer region of the cam body, since as previously described in relation to the protrusion, the force moment produced on the cam body will be greater when the prong is a greater distance from the central axis of the cam body. To achieve these, the at least one prong may extend from a rear wall of a corresponding hook part.

In an embodiment, the at least one prong is arranged to be able to flex in at least a radially inward direction. As described in further detail later, the at least one prong is arranged to cooperate with a taper section of the housing, so that the prong is flexed radially inward when the cam body is pushed into the housing. In this way, the prong is able to act as a spring element to drive the cam body back along the engagement axis towards the first operational element. This improves the ease of operation of the device. In addition, the user will notice a resistance when he is driving the conduit in the direction of the second operational element, which may act as a signal to him that he needs to press the conduit in further.

However, it is also thinkable that a separate spring element is provided, for instance within the housing, against which the cam body bears when the cam body is inserted into the housing. This would achieve a similar effect to the flexing action of the at least one prong.

The at least one prong may comprise a tail part, a body part and a head part. The tail part may extend partially radially inwardly, which can assist in the generation of a spring force, in particular because it results in the formation of more than one bending point for the prong—a first bending point where the tail part is joined to the cam body, and a further bending point where the tail part is joined to the body part. It is conceivable to also provide further bending points.

The body part may extend parallel to the central axis. This part can thereby contribute a majority of axial extension of the prong, reducing the axial distance the cam body has to travel until the prong contacts the second operational element.

The head part may be configured to contact the second operational element. In particular, fingers of the head part, which may comprise a first pointed portion, may be configured to contact the second operational element. The first pointed portion may therefore be arranged to point along the central axis (i.e. along the engagement axis). The pointed portions have an incline, which may be formed to match the incline of a sloping region on the second operational element. The head part may also comprise a second pointed portion, which may be arranged to contact a taper section in the housing to cause the prong to flex. The second pointed portion may therefore have an incline which matches the incline of the taper section.

The cam body is formed to be able to slide axially within the first operational element. The outer shape of the cam body and the inner shape of the first operational element thereby complement each other.

A central axis extends through the centre of the cam body. The radial direction is perpendicular to the central axis, and the axial direction is parallel to the central axis. Preferably, per an embodiment, the cam body is rotationally symmetrical about its central axis (has e.g. twofold rotational symmetry).

### Features Related to the First Operational Element

The conversion mechanism may comprise a first operational element and second operational element. This section describes embodiments, configurations and constructions of and related to the first operational element. Where deemed necessary or helpful, aspects of disclosure mentioned previously may be repeated or discussed in greater detail.

The first operational element may comprise sloping regions, as also described in the section headed “Sloping Regions” or under the section related to the second operational element. The sloping regions may be included as part of a first engagement profile of the first operational element.

In some embodiments, the first engagement profile is formed in the top side of one or more walls of the first operational element. This may reduce the distance that a cam body has to travel before it can engage with the first engagement profile.

The first engagement profile may comprise first sloping regions configured to cooperate with the cam body. Said sloping regions may be configured to curve in the circumferential direction around the engagement axis. Preferably, per an embodiment, the first sloping regions have a constant width in the circumferential direction.

Preferably, per an embodiment, the gradient of incline of the first sloping regions is the same. However, it is thinkable that different gradients of inclined are provided, for instance depending on how much force should be required to move the cam body between positions.

Preferably, per an embodiment, the first sloping regions all slope in the same direction. The first engagement profile comprises sloping regions around the entire circumference of the first operational element. Preferably, per an embodiment, the sloping regions are arranged to face along the engagement axis, for instance such that their slope surfaces slope only in the circumferential direction.

The first engagement profile may comprise stops, which hinder or prevent the cam body from rotating when the cam body is engaged with them. The stops may also be included as part of the first engagement profile. This permits control of the exact position to which the cam body should rotate when it is driven against the first operational element. According to an embodiment, the stop regions are arranged to be at the bottom of sloped regions, so that the cam body is stopped once it has undergone the full amount of rotational movement that a sloping region can impart.

The stops may be formed, for example, by walls or steps. Preferably, per an embodiment, a wall or step extends parallel to the engagement axis. However, it is thinkable that the wall or step is inclined relative to the engagement axis, which may make it easier or more difficult to rotate the cam body out of a stop position, depending on the direction of incline of the stop, wall or step. Preferably, per an embodiment, the height of a stop region (in the direction along the engagement axis) is equal to the height of an adjacent sloping region.

In an embodiment, the first operational element may comprise one or more slots, which in one function facilitate movement of the cam body into a locking position. In another function, they partially act as stops. Slots may also be included as part of the first engagement profile. A slot may be formed through the removal of material from the first engagement profile along the engagement axis. In particular, the slot may extend further in the direction towards the base than any other region in the engagement profile. Preferably, per an embodiment, the slots extend from a top side of the one or more walls down to a base of the first operational element. This provides a maximum extent of movement for the cam body. Slots may be formed by a space formed between two or more walls in the circumferential direction of the first operational element.

A slot may comprise two walls formed in the first engagement profile, in particular which are parallel to each other and also parallel to the engagement axis. The slot may comprise, in the region of its base, angles of 90 degrees. In other words, the slot may have a rectangular or square shape. However, other shapes are thinkable.

In one example, the first engagement profile comprises two slots arranged opposite to each other on the engagement profile, e.g. at an angle of 180 degrees from each other. Depending on how many unlocking or locking positions should be provided, more or fewer slots (or first sloping regions or stops) may be provided.

The first operational element may comprise a base, for instance formed as a ring, to which is attached one or more wall pieces. The one or more wall pieces may extend along the outline of the base. In some embodiments, the wall pieces are fixed to the fixed by adhesive, by a snap-in geometry or they may be formed as one piece with the base.

The first operational element may be configured so that a cam body occupies a locking position when the cam body is engaged with the slot. In particular, a slot of the first operational element may be configured to accommodate a protrusion of the cam body.

In an embodiment, the first operational element comprises an internal space for accommodating the cam body, at least partially. The space may be formed as a cylindrical recess within the first operational element.

In order to prevent the cam body from passing all the way through the first operational element, the first operational element may comprise a stop. This stop may be formed as a flange, for instance a circular flange, which extends around a base of the first operational element. For maximum security, the flange may extend all the way around the base.

Preferably, per an embodiment, in an internal region, the first operational element comprises a locking region which is formed to prevent the attachment mechanism for the conduit from opening. This region may be a region which forms an interlock or shape lock with the attachment mechanism. For instance, the locking region may be a region whose diameter prevents the attachment mechanism for opening, for example, a region whose diameter prevents legs of the attachment mechanism from being displaced radially outwards. The locking region may comprise an inclined region, which in some embodiments extends around the entire inner circumference of the first operational element, preferably in the region of the base of the first operational element. In some embodiments, the locking region also comprises or consists of the flange.

In an embodiment the first operational element is configured to allow the attachment mechanism to unlock only when the cam body is in the unlocking position, in particular when the cam body is engaged with the first operational element (i.e. when the cam body is in contact with the first operational element). For instance, at least one inner recess may be formed in an inner wall of the first operational element to provide a space for the attachment mechanism to unlock. Preferably, per an embodiment, the recesses are formed on inner circumferential walls of the first operational element, in particular when the attachment mechanism comprises legs that are displaced radially outward to open the attachment mechanism.

In an embodiment, the first operational element comprise four recesses formed on inner circumferential walls and which are arranged at equal distances from each other, in particular 90 degrees from each other.

In some embodiments, at least one recess is aligned at least with the at least one slot (i.e. the recess is formed in the same part of circumferential wall of the first operational element as the slot). This is beneficial according to an embodiment when, on the cam body, the relevant part of the attachment mechanism (for instance, leg) and the part of the cam body that engages the first engagement profile (for instance, the protrusion) are aligned with each other. Where this is not the case, the recess may be positioned in a different part of the circumferential wall relative to the slot.

The first operational element comprises means to secure the first operational element relative to rotation and/or relative to movement along the engagement axis, when the first operational element is present in the housing. Said means may comprise an adhesive, an interlock connection or a force connection. In one embodiment, securing members are provided in the form of protrusions arranged around the outer circumference of the first operational element to engage with corresponding recesses in the housing. The protrusions may comprise snap-in elements, for instance.

Preferably, per an embodiment, the surface of the first engagement profile is smooth, so that the ability of a part of a cam body to contact and move over the surface is not hindered impeded.

The first operational element may be arranged closer to the opening of the housing along the engagement axis that the second operational element. In particular, the first operational element may be arranged in the opening of the housing. Preferably, per an embodiment, the first operational element is formed as a separate part, but it is also thinkable that it is formed as one piece with the housing.

In order to be able to accommodate a conduit, the first engagement element has an opening, typically of circular shape.

Preferably, per an embodiment, the first operational element is configured to cooperate with the cam body such that through engagement of the cam body with the first operational element, motion of the cam body along the engagement axis is converted into rotational motion of the cam body around the engagement axis.

### Features Related to the Second Operational Element

The conversion mechanism may comprise a first operational element and second operational element. This section describes embodiments, configurations and constructions of and related to the second operational element. Where deemed necessary or helpful, aspects of disclosure mentioned previously may be repeated or discussed in greater detail.

Preferably, per an embodiment, the second operational element is configured to cooperate with the cam body such that through engagement of the cam body with the second operational element, motion of the cam body along the engagement axis is converted into rotational motion of the cam body around the engagement axis.

The second operational element may comprise sloping regions, as also described in the section headed “Sloping Regions” and under the section relating to the first operational element. The sloping regions may be included as part of a second engagement profile of the second operational element. Said sloping regions may be configured to extend or curve in the circumferential direction around the engagement axis. Preferably, per an embodiment, the second sloping regions have a constant width in the circumferential direction.

In some embodiments, the second engagement profile is formed in the top side of one or more walls of the second operational element. This may reduce the distance that a cam body has to travel before it can engage with the second engagement profile.

Preferably, per an embodiment, the gradient of incline of the second sloping regions is the same. However, it is thinkable that different gradients of incline are provided, for instance depending on how much force should be required to move the cam body between unlocking and locking positions.

Preferably, per an embodiment, the second sloping regions all slope in the same direction. The second engagement profile comprises sloping regions around the entire circumference of the second operational element. Preferably, per an embodiment, the sloping regions are arranged to face along the engagement axis, for instance such that their slope surfaces slope only in the circumferential direction.

The present inventors have concluded that in certain embodiments an ideal number of slopes is four, spaced apart from each other at equal distances. However, more or fewer may be incorporated depending on the requirements of an individual line connector.

The second operational element may comprise stops, which hinder or prevent the cam body from rotating when the cam body is engaged with them. The stops may also be included as part of the second engagement profile. This permits control of the exact position to which the cam body should rotate when it is driven against the second operational element. Beneficial per an embodiment is that the stop regions are arranged to be at the bottom of sloped regions, so that the cam body is stopped once it has undergone the full amount of rotational movement that a sloping region can impart.

The stops may be formed, for example, by walls or steps. Preferably, per an embodiment, a wall or step extends parallel to the engagement axis. However, it is thinkable that the wall or step is inclined relative to the engagement axis, which may make it easier or more difficult to rotate the cam body out of a stop position, depending on the direction of incline of the stop, wall or step. Preferably, per an embodiment, the height of a stop region (in the direction along the engagement axis) is equal to the height of an adjacent sloping region.

The second operational element may comprise a base, for instance formed as a ring, to which is attached one or more wall pieces. The one or more wall pieces may extend along the outline of the base. In some embodiments, the wall pieces are fixed to the fixed by adhesive, by a snap-in geometry or they may be formed as one piece with the base.

In an embodiment, the second operational element is formed as a separate part, which ensures that it can be machined easily. However, in this case, the second operational element and the housing should be configured for securing the second operational element inside the housing in a rotationally and longitudinally (that is, with respect to movement along the engagement axis) fixed manner, via a fixing geometry. This may occur by means of a suitable snap in connection that comprises protrusions for preventing rotation, for instance. Alternatively or additionally, an adhesive or a force connection could be used. It is also conceivable that the second operational element is formed as a single part with the housing.

Where the second operational element is formed as a separate part, it is possible that it comprises a circumferential groove, which is engaged by another protrusion, potentially a circumferential protrusion, of the housing to prevent movement along the engagement axis. The second operational element may be suitably secured using similar or identical means as for the first operational element. It shall be understood that reference to grooves and protrusions may be reversed where the effect would be the same.

A front face of the second operational element may comprise stepped regions to enable the second slopes to have an increased gradient. In other words, the stepped regions may be located between the bottom of a slope and the top of a neighbouring slope. The stepped regions allow an immediate increase in height (i.e. in the direction parallel to a central axis of the second operational element), as opposed to an incline, which provides a gradual increase in height.

In an embodiment, the second operational element has rotational symmetry about the engagement axis. In particular, it may have fourfold rotational symmetry. In order to be able to accommodate a conduit, the second engagement element may have an opening, preferably of circular shape.

Preferably, per an embodiment, the line connector is configured such that, when the first and/or second operational elements are present in the housing, linear movement of the cam body can be converted into rotational motion of the cam body.

Safety Latch Features

The line connector may comprise a safety latch. This section describes embodiments, configurations and constructions of and related to the safety latch.

The line connector may comprise a safety latch configured to prevent the cam body from moving from one rotational position to another rotational position. In an embodiment, the safety latch is configured to prevent the cam body from moving from a locking position to an unlocking position, or vice versa, for example from a retracted position to a protracted position. Preferably, per an embodiment, any one of the preceding features is achieved in that the safety latch comprises a safety pin configured to be inserted into the housing. In an embodiment, the insertion of the safety pin blocks the cam body from moving from one rotational position to another rotational position, e.g. from a locking position to an unlocking position, and preferably from a retracted position to a protracted position.

The safety latch may comprise a plurality of legs, preferably two in an embodiment, whereby the safety pin is arranged between the legs. In particular the safety latch may have a U-shaped or C-shaped profile, with a central (lateral or curved) portion joined at each end to a longitudinal portion. The safety latch may also be configured to be secured to the housing, for instance by means of an attachment mechanism, or by protrusions which mate which corresponding recesses or openings in the housing, or vice versa.

In an embodiment, the safety latch and the line connector are configured such that in an unlocking position of the cam body, the safety latch cannot be engaged (for instance by pushing down on the safety latch), and in a locking position of the cam body, the safety latch can be engaged (for instance by pushing down on the safety latch). In one example of the disclosure, the safety latch and the line connector are configured so that displacement of the cam body from an unlocking position to a locking position causes the safety latch to be moved from a position where engagement is not possible, to a position where engagement is possible.

In an unlocking position of the cam body, at least one protrusion of the safety latch may be configured to protrude at least partly into the housing. In one example, at least one leg of the safety latch comprises formed along its length. Preferably, per an embodiment, each leg comprises a protrusion in the region of its end furthest from a central portion of the safety latch.

The at least one protrusion may comprise at least one displacement region configured to allow the safety latch to be displaced or engaged and at least one securing region configured to prevent the safety latch from being displaced or engaged. In particular, the securing region may be formed to cooperate with the housing, for instance via a shaped locking connection, to prevent movement of the safety latch in the engagement direction. The securing region may comprise a flat, non-inclined region and the displacement region may comprise an inclined surface in some embodiments.

The at least one protrusion of the safety latch may be configured such that in a first insertion position, the at least one securing region is engaged and in a second insertion position, the at least one securing region is not engaged. Further, in the first insertion position, the displacement region may be configured to cooperate with the cam body, such that a portion, e.g. a protrusion, of the cam body (in particular movement thereof) is able to cause the protrusion of the safety latch to move from the first insertion position to the second insertion position. Preferably, per an embodiment, the line connector is configured such that this occurs by movement of the cam body from an unlocking position to a locking position and bearing against the displacement region.

The safety latch is configured per an embodiment such in the second insertion position, the at least one protrusion extends, for instance through an opening, some or no distance into the housing, and in the first insertion position, the at least one protrusion extends further into the housing than in the second insertion position. In some embodiments, in the first insertion position, the at least one protrusion is fully inserted into the housing.

A protrusion of the cam body may be arranged to cooperate with the protrusion of the safety latch, in particular its displacement region, when the protrusion of the safety latch is in the first insertion position. In some embodiments, the line connector and the safety latch are configured such that the protrusion is moved from the first insertion position to the second insertion position by movement of the cam body along the engagement axis, in particular when a conduit is pulled towards a user in the direction out of the housing. It is also conceivable that rotational movement of the cam body is able to cause said movement. Said movement may be effected by a radially extending protrusion of the cam body. Where said movement is caused by motion of the cam body along the engagement axis, the protrusion may be provided with an inclined region along the engagement axis, such that movement and engagement of the cam body against said inclined region is able to cause movement of the protrusion in a radially outwards direction.

Since in the second insertion position the protrusion may still be partially inserted into the housing, the protrusion may also comprise, in its displacement region, an inclined region configured to cooperate with the housing to allow the safety latch to be engaged. In particular, when the safety latch is pressed down, the further inclined region may be configured to engage with the housing to cause the protrusion to be displaced entirely out of the housing, thereby allowing the safety latch to be fully engaged. Said inclined region may be arranged to face in the direction of engagement of the safety latch. The engagement direction is the direction that the safety latch moves in when it is engaged.

The safety latch may further comprise at least one catch element, which acts to secure the safety latch from removal from the housing. The at least one catch element may be configured to engage a groove formed on an outside surface of the housing.

Preferably, per an embodiment, the housing comprises at least one second opening arranged along the engagement direction of the safety latch. The at least one second opening is preferably configured to accommodate the protrusion of the safety latch when the safety latch is in an engaged position. It is also conceivable that the at least one second opening acts to hinder disengagement of the safety latch.

In some embodiments, the at least one second opening is a blind opening and comprises an inclined surface, which may be configured to cooperate with the at least one protrusion of the safety latch. In this way, may be possible for the user to disengage the safety latch simply by pulling it along a disengagement direction, in that the protrusion of the safety latch bears against the inclined surface of the second opening.

In an embodiment, the housing comprises a second opening for each protrusion. There may therefore be two second openings arranged on opposite side of the housing.

### Housing

The line connector comprises a housing. This section describes embodiments, configurations and constructions of and related to the housing. Where deemed necessary or helpful, aspects of disclosure mentioned previously may be repeated or discussed in greater detail.

The housing may comprise a taper section, having a first end of larger diameter and a second end of narrower diameter. The taper section may be configured to engage the cam body, in particular at least one prong of the cam body, in order to create a spring force on the cam body.

Preferably, per an embodiment, the taper section extends around the entire inner circumference of the housing. The level of slope of the taper section may be varied depending on the amount of spring force required. Preferably, the surface of the taper section is smooth.

Further, the taper section and the second operational element may be configured such that a prong is led into contact with the second operational element by the taper section when the cam body is displaced towards the second operational element. This enables the prong to both provide a spring function and also to act to rotate the cam body through engagement with the second operational element.

A conduit to be used with the present line connector may comprise a protrusion. Preferably, per an embodiment, the conduit comprises a circumferential collar, which preferably extends all the way around the circumference of the conduit.

A distance between the first operational element and second operational element along the engagement axis should be sufficient to allow the cam body to rotate freely. In other words, parts of the cam body should not crash against the second operational element when the cam body is being rotated by engagement with the first operational element, and vice versa.

Preferably, per an embodiment, the housing is configured to allow a conduit to be moved along the engagement axis when the conduit is inserted, in order that it is possible to push and pull the conduit to move the cam body. This may achieve by providing the third chamber of the housing with a suitable length, for instance.

In an embodiment, the cam body and the conversion element (or, the first operational element and the second operational element) each have collinear openings suitable to receive a conduit.

In another optional example, the housing may have at least one internal first sealing ring, in order to ensure a good seal between an inserted spigot and the housing. Preferably, per an embodiment, the first sealing ring is received in the second chamber of the housing beyond the conversion element (or in particular, the second operational element). This ensures that the presence of the first sealing ring does not interfere with the engagement mechanism.

The at least one first sealing ring may be combined with an adjacent guide ring. Said guide ring may function to guide the spigot through the rest of the housing, in particular into the third chamber.

In order to ensure a particularly good sealing effect, according to an embodiment, a second sealing ring may be provided in addition to the first sealing ring. Where a guide ring is used, the two sealing rings may be arranged at each side of the guide ring.

The terms “groove”, “recess”, “notch” or “slot” and the terms “protrusion”, “foot” or “bar”, or any other apparent terms, may be exchanged where these elements are used to form a shape-fitting connection between two parts, in particular where these elements are used to fix rotational or linear motion.

The term “engagement” may be used in the sense “to bring together”, however it may also be used to mean to engage a lock or to cause a mechanism to operate. In the present application, the engagement mechanism is typically used in connection with locking and unlocking the line connector. However, it is also thinkable that the mechanism could also be used to bring a conduit in and out of a position where it inserted into (or removed from) an opening.

The engagement axis is the axis along which the cam body linearly moves to engage with the first and/or the second operational element. This may also be the longitudinal axis of the housing and the axis along which a conduit is inserted.

Usually, the inward direction shall be understood to meet in the direction into the housing (i.e. into the insertion opening of the housing), and the outward direction shall be meant the direction out of the housing (i.e. out of the insertion opening of the housing). The term “radial” refers to the radial direction, i.e. the direction of a radius of a circle force around, for instance, a particular axis. The term axial means along a particular axis. The term circumferential means in the direction about a particular axis, sometimes along a circular path.

It should be noted that the terms “first” and “second” are used as labels and are not used to explicitly denote position or function unless this is described. In particular, the first operational element and the second operational element may have their positions reversed within the housing, and the first operational element may have the features and profile of the second operational element.

In applicable embodiments, the engagement mechanism encompasses the cam body and the conversion mechanism, whereby the conversion mechanism can further encompass the first operational element and the second operational element.

In general, where reference is made to a conduit, this may also be to a spigot, since it is the spigot of the conduit which is attached into the line connector.

Ideal materials for the manufacture of the various components are polymers, in particular hard plastics. However, depending on requirements, other hard materials may also be used, such as metal. The cam body may require in some embodiments that a more flexible material is used, so that it is able to flex radially to open the attachment mechanism.

### BRIEF DESCRIPTION OF THE DRAWINGS

Further features, details and advantages of the disclosure arise from the wording of the claims as well as from the following description of embodiments with the help of the figures. These show:

FIG. 1a an exploded view of the line connector and safety latch;

FIG. 1b an exploded view of a further embodiment of the line connector and safety latch;

FIG. 2 a front perspective view of the first operational element;

FIG. 3 a rear perspective view of the first operational element;

FIG. 4 a front view of the first operational element;

FIG. 5 a side view of the first operational element;

FIG. 6 a front perspective view of the second operational element;

FIG. 7 a front view of the second operational element;

FIG. 8 a front perspective view of the cam body;

FIG. 9 a side view of the cam body;

FIG. 10 a rear view of the cam body;

FIG. 11 a front perspective view of the housing;

FIG. 12 a side cross-sectional view of the housing;

FIG. 13a a side cross-sectional view of the line connector and conduit in the unlocking position;

FIG. 13b a further side cross-sectional view of another embodiment of the line connector and conduit in the unlocking position;

FIG. 14 a perspective view of the line connector with the cam body in an unlocking position with a protrusion bearing against a stop on the first operational element;

FIG. 15 a perspective view of the line connector with the cam body moved out of the unlocking position and beginning to engage with the second operational element;

FIG. 16 a perspective view of the line connector with the cam body engaged with the second operational element and bearing against a stop surface thereof;

FIG. 17 a side view of the cam body in a locking position, showing a protrusion in the slot of the first operational element;

FIG. 18 a side cross-sectional view of the line connector in the locking position;

FIG. 19 a perspective view of the safety latch;

FIG. 20 a perspective view showing the safety latch in a disengaged position;

FIG. 21 a perspective view showing the safety latch in a disengaged position with the protrusions of the legs of the safety latch in a first insertion position; and

FIG. 22 a side cross-sectional view showing the safety latch in a disengaged position.

### DETAILED DESCRIPTION

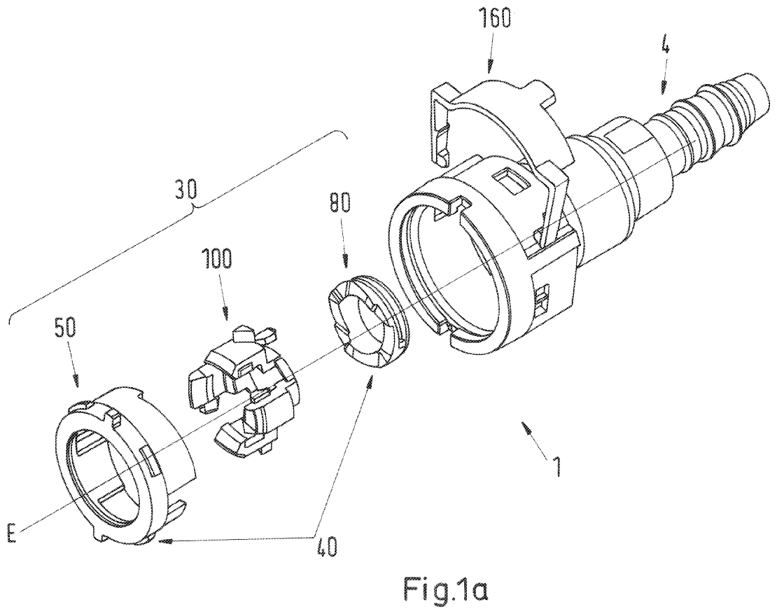

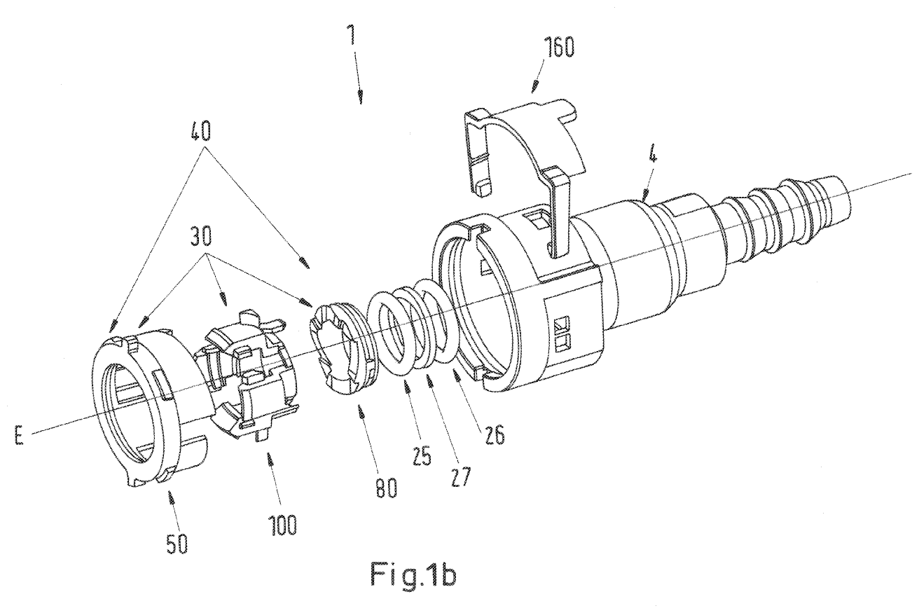

FIGS. 1a and 1b show an exploded view of the line connector 1 and safety latch 160. This is described further in conjunction with other figures later.

### First Operational Element

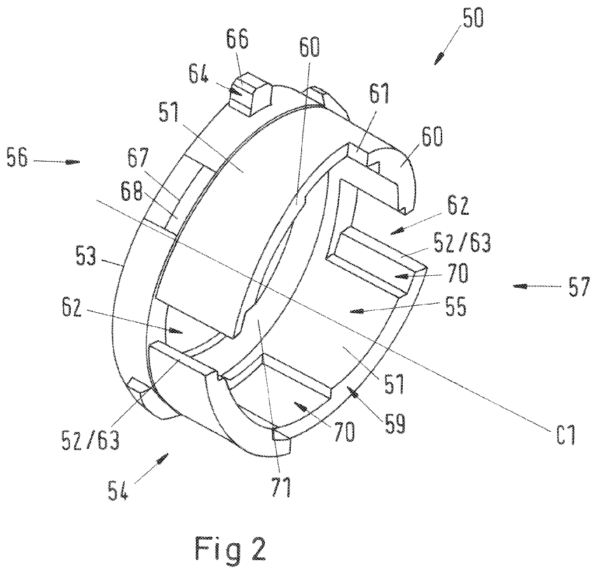

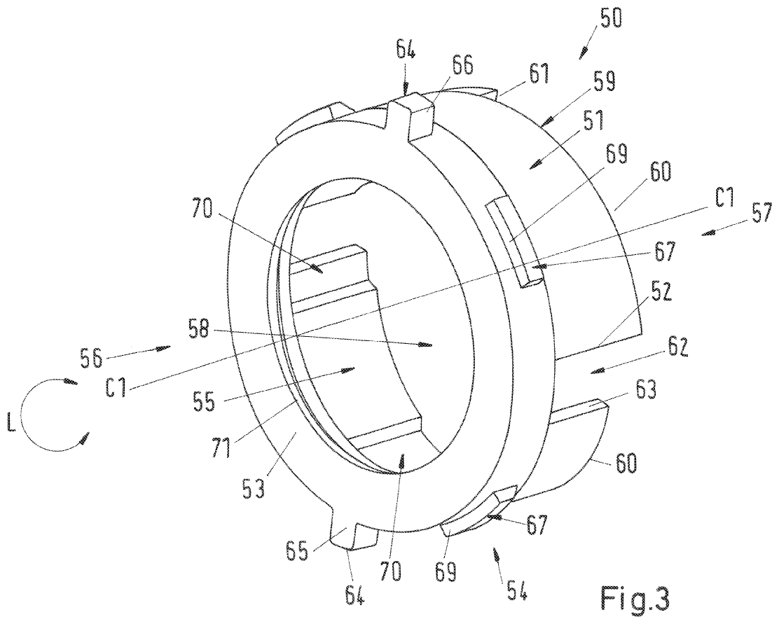

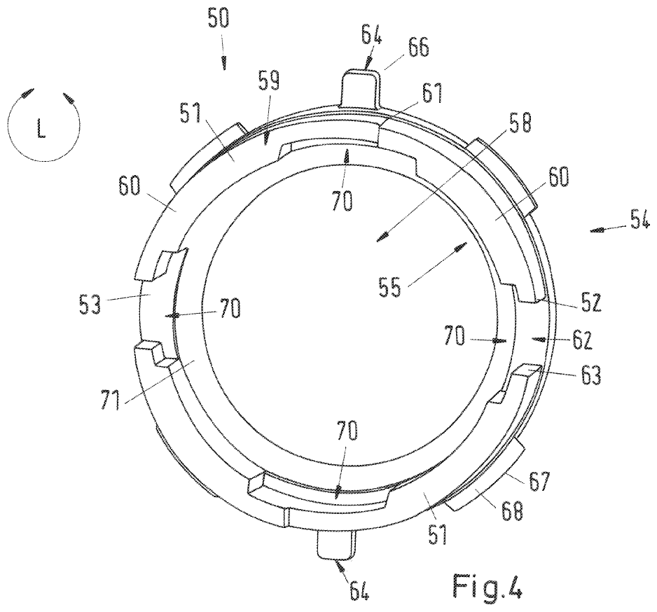

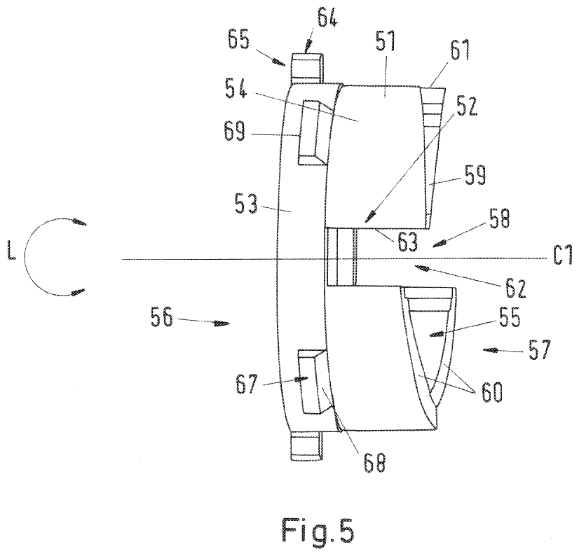

FIGS. 2 to 5 show various views of the first operational element 50, which is essentially formed as a ring. The first operational element 50 has two substantially semi-circular walls 51 joined at a ring-shaped base 53. There is an outer side 54, an inner side 55, a bottom side 56, and a top side 57, as well as a central opening 58 suitable to receive a conduit not shown. In use, the bottom side 56 faces out of a housing and the top side 57 faces into a housing.

Each wall 51 is provided with a first engagement profile 59 in a top of the wall at the top side 57, against which a cam body may be driven along the central axis C1, which in use is aligned with the engagement axis E, to effect rotational motion of the cam body about the engagement axis. Followed in the clockwise direction when viewed from the top side 57, the first engagement profile 59 consists of a repeating motif as follows:

A declining first sloping region 60, followed by a stop 61, followed by another first sloping region 60. The height of the stop 61 i.e. extension along the central axis C1 is equal to the drop of the sloping region along the central axis C1.

The end 52 of each wall 51 is separated from the neighbouring end 52 of the other wall 51 by a certain distance in the circumferential direction L, which results in the formation of two identical slots 62. The first operational element 50 thus has twofold rotational symmetry about its central axis C1.

One function of the slots 62 is to facilitate movement of a cam body into the locking position. In addition, the stops 61 facilitate movement and retention of a cam body in the unlocking position.

The sides 63 of each slot 62 which are also the ends 52 of the walls 51) are straight and parallel to each other.

Feet 64 are arranged at the outer side 54 of the base 53 directly opposite each other, i.e. 180 degrees apart. Each foot 64 is essentially a cuboid joined by one face to the outer side 54 of the base 53. Each foot 64 is positioned such that a bottom face 65 thereof is parallel with the bottom side 56 of the base 53. In other words, each foot 64 appears to extend radially outwardly from the base 53. However, the extension of the foot 64 parallel to the central axis C1 is less than the extension of the base 53 parallel to the central axis C1, in particular, the length of the foot 64 is approximately three quarters of the length of the base 53. Edges 66 of the foot 64 parallel to the central axis C1 are rounded. The feet 64 function to prevent rotational movement of the first operational element 50 when it is inserted into a housing.

The first operational element 50 also comprises four bars 67 positioned around the outer side 54 of the base 53, said bars 67 functioning as snap-in elements to hold the first operational element 50 in a housing and thereby prevent motion along the engagement axis E, i.e. along the central axis C1 of the first operational element 50. Each bar 67 is arranged at approximately 90 degrees in the circumferential direction L to its neighbouring bars 67. A front side 68 of the bar is inclined in order to assist in inserting the first operational element 50 into a housing. A rear side 69 of the bars 67 is not inclined and instead is parallel with the bottom side 56 of the base 53.

First operational element 50 has four inner recesses 70 formed in the walls 51 at the inner side 55. Two of the recesses 70 are each formed entirely within one of the walls 51, and two recesses 70 each span two of the walls 51, in particular in the region of the slot 62. The recesses are arranged at equal intervals from each other at 90 degrees.

The base 53 has a flange 71 to prevent a cam body from falling out of the first operational element 50 and to act to surround an attachment mechanism of a cam body to prevent it from opening when a cam body in within the first operational element 50 in a locking position. The flange 71 extends around the entire circumference of the first operational element 50.

### Second Operational Element

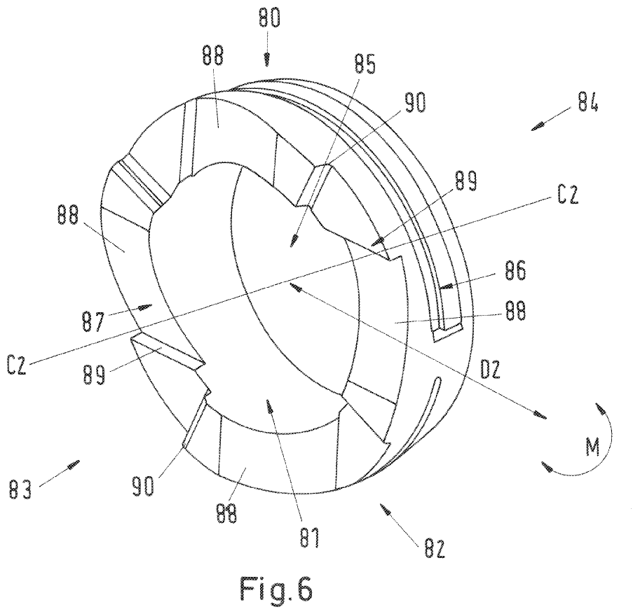

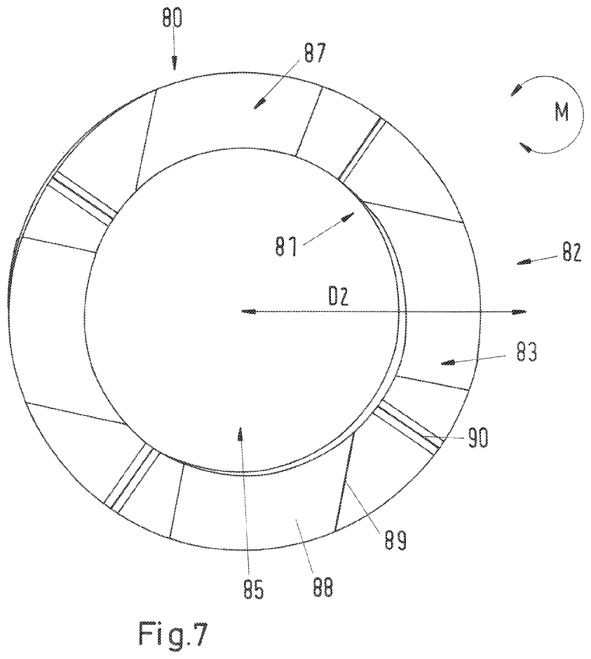

FIGS. 6 and 7 show various views of the second operational element 80, which has the shape of a ring and has an inner side 81, an outer side 82, a top side 83 and a bottom side 84. The bottom side 84 is arranged to face into a housing when the second operational element 80 is arranged in therein, and the top side 83 is arranged to face out of a housing, with the outer side 82 contacting an inner region of the housing to hold the second operational element 80 in place. A central opening 85 is suitable to receive a conduit.

In its outer side 82, the second operational element 80 has two circumferential grooves 86.

Provided at the top side 83 of the second operational element 80 is a second engagement profile 87, against which a cam body may be driven along an engagement axis (i.e. along the central axis C2) to effect rotational motion of the cam body thereabout. Followed in the anti-clockwise direction when viewed from the top side 83, the second engagement profile 87 comprises of a repeating motif as follows:

A declining second sloping region 88, followed by a stop 89, followed by a step region 90, which joins onto the start of the next second sloping region 88. This motif repeats four times. The engagement profile 87 therefore has fourfold rotational symmetry about the central axis C2 of the second operational element 80.

The second sloping regions 88 are all arranged to slope in the same circumferential direction M and such that the slopes all decline in an anti-clockwise direction R. The surface of the second engagement profile 87 between the stop 89 and the step region 90 and the step region 90 and the top of each slope is flat and even, i.e. the surface extends parallel to the radial direction.

Each step region 90 extends parallel to the radial direction D2 at that particular location of the second engagement profile 87. It can be seen that each stop 89 does not extend parallel to the radial direction D2, but rather cuts the ring at an angle.

### Cam Body

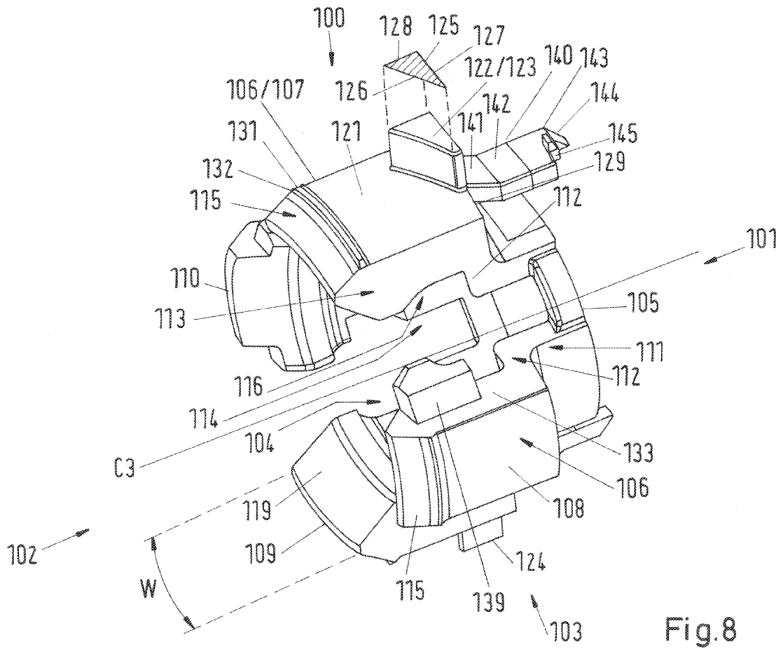

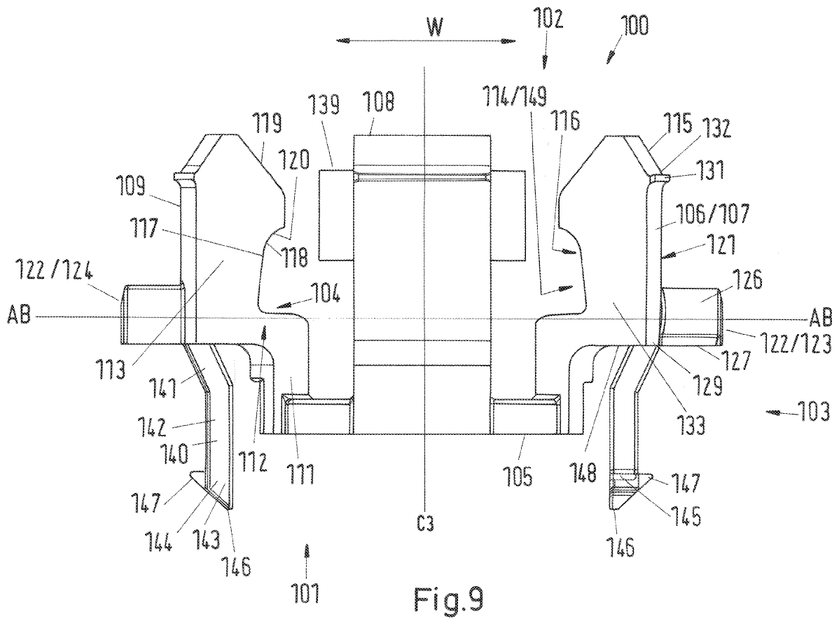

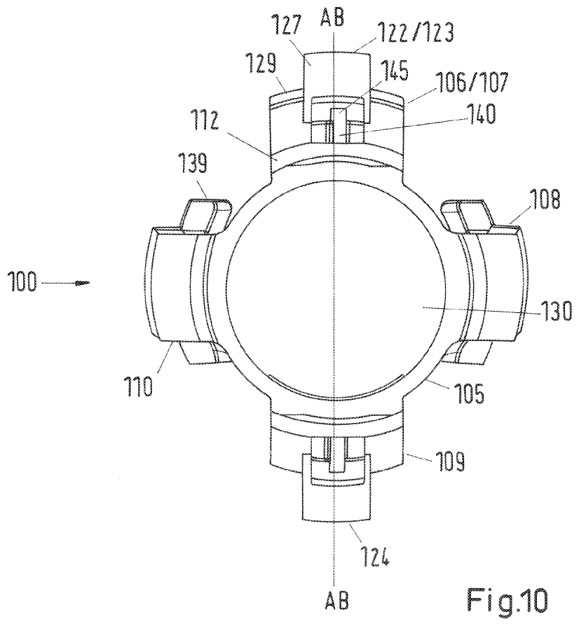

FIGS. 8 to 10 show various views of the cam body 100. The cam body 100 has a back side 101, a front side 102, an outer side 103 and an inner side 104. At the back side 101 is a foundation 105, formed in this case in the shape of a ring, to which are attached four legs 106—a first leg 107, a second leg 108, a third leg 109 and a fourth leg 110—extending in the same direction along the central axis C3. The four legs 106 are spaced equally from each other around the circumference of the foundation 105. An angle between each leg 106 is therefore 90 degrees, within typical tolerances. The legs 106 are attached to the foundation 105

Each leg 106 has a joining piece 111, which connects the leg 106 to the foundation 105, a radially extending part 112, which is joined to the joining piece 111 and extends in the direction perpendicular to the central axis C3, and a hook part 113, which is joined to the radially extending part 112 and extends in the direction parallel to the central axis C3. In this application, the term “leg” may be used to refer to the combination of the hook part 113, the radially extending part 112 and the joining piece 111.

Each leg 106 and its hook part 113 comprise part of the attachment mechanism 149. Each hook part 113 has a recess 116 on the inner side 104 of the cam body 100, which is what lends the hook parts 113 their hook-like form for attaching an inserted conduit. The profile of the recess 116 comprises a throat 117 connected to a bend 118, whereby the throat 117 extends at a slight incline relative to the central axis C3 and the bend 118 curves substantially so that it extends essentially perpendicular to the central axis C3 at the end of the bend 118. The region of the bend 118 may also be termed the “inner inclined region” in other parts of this application, which is the part which serves to aid in guiding a conduit out from the attachment mechanism 149. The profile of the recess 116 extends over the entire width that is, the extension of the recess 116 in the circumferential direction of the respective hook part 113.

At the front side 102 of each hook part 113 is a front inclined region 119, which aids in inserting a conduit into the attachment mechanism 149. This front inclined region 119 extends over the entire width that is, the extension of the leg in the circumferential direction) of the respective hook part 113.

The width as defined previously of each hook part 113 is substantially the same in the direction parallel to the central axis C3. In other words, internal sides 133 of each hook part 113 are parallel to each other.

Each hook part 113 has a top face 121 at an outer side 103 of the cam body 100. For first and third hook part (of the first leg 107 and the third leg 109 arranged at opposite positions on the foundation 105, that is, at around 180 degrees from each other, a protrusion 122 is formed as part of the top face 121, to give a first protrusion 123 and a second protrusion 124. When viewed along the straight line AB, which extends through both the first protrusion 123 and the second protrusion 124, the first protrusion 123 has a cross-section 125 that may be regarded as a right-angled triangle. The triangle of the cross-section 125 has a hypotenuse 126, a base 127 and a side 128, and is arranged so that the base 127 is parallel to a rear edge 129 of the top face 121 of the hook part 113, such that the right angle of the triangle is partially flush with the rear edge when looking along the line AB. The side 128 of the triangle (which forms the right angle with the base 127 extends perpendicular to the rear edge 129 of the top face 121. The second protrusion 124 has the same form as the first protrusion 123.

The curvature of the protrusion at the outer side 103, of the top face 121 of the hook part 113 and of the inclined regions of respective hook parts 113 mirrors the curvature of the foundation 105.

Each hook part 113 has a lip 131 which is situated at the interface 132 between a top inclined region 115 and the top face 121. The lip 131 extends perpendicular to the central axis C3 across the entire width of the hook part 113 at the outer side 103.

Each leg 106 has two internal sides 133. On each internal side 133 of the second leg 108 and the fourth leg 110 are arranged flanks 139, in particular on the internal sides 113 of the second and fourth hook parts.

Each first leg 107 and third leg 109 also comprises a prong 140 which is arranged on a rear wall 148 of the respective hook part 113. Each prong 140 extends substantially parallel to the central axis C3. Each prong 140 extends past the foundation 105 in the direction of the central axis C3.

Each prong 140 comprises a tail part 141, which extends partially radially inwardly, the tail part 141 being joined to a body part 142, which extends parallel to the central axis C3, the body part 142 being joined to a head part 143. The tail part 141 and the body part 142 have the same width (in the circumferential direction and the same height (in the radially outward direction.

The head part 143 comprises a first finger 144 and a second finger 145. Each finger 144, 145 is formed substantially by a cuboid joined to a pointed portion 146, 147 having the form of a triangular prism. The first finger 144 and second finger 145 are joined to each other, arranged side by side and are arranged such that their pointed portions 146, 147 point at right angles from each other. In particular, a first pointed portion 146 of the first finger 144 points parallel to the central axis C3 in the direction away from the hook part 113, and the second pointed portion 147 of the second finger 145 points perpendicular thereto in the radially outward direction.

The cam body 100 has twofold rotational symmetry about its central axis C3.

### Housing

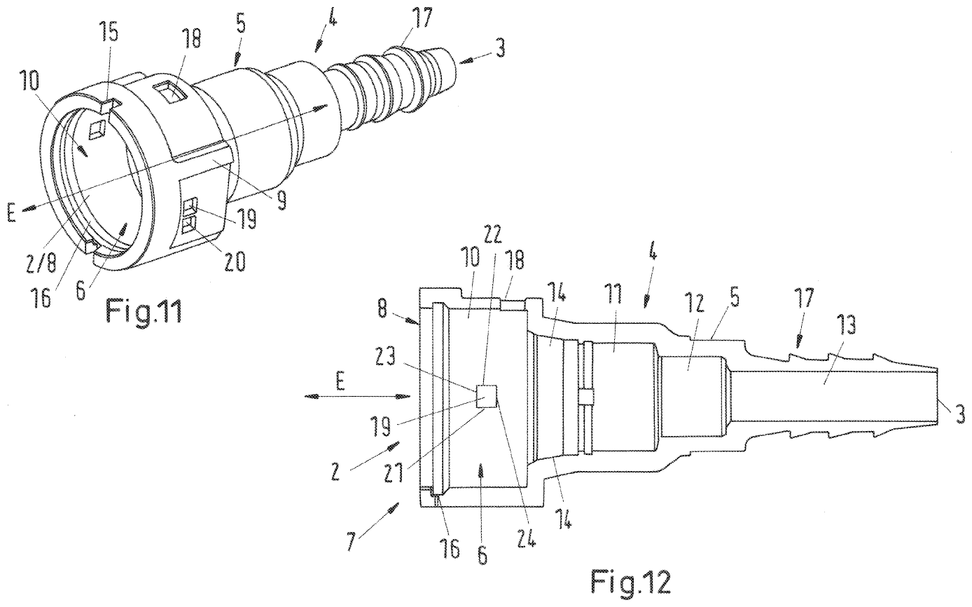

FIGS. 11 and 12 show views of the housing 4, which has an internal structure comprising a series of chambers of increasingly smaller diameter, namely a first chamber 10 of largest diameter, a second chamber 11 and a third chamber 12, and a fourth chamber 13 of smallest diameter. The housing 4 has an outer surface 5, an inner surface 6, an insertion opening 8 and an exit opening 9.

The first chamber 10 is arranged to accommodate the first operational element 50 and the cam body 100. The housing 4 comprises two notches 15 formed in its front surface 7 arranged opposite each other, that it at 180 degrees to each other. These notches 15 are arranged to mate with the feet 64 of the first operational element 50 to prevent rotational movement of the first operational element 50 within the housing 4. For this purpose, the housing 4 also features a groove 16 formed in the inner surface 6 of the first chamber 10 and which extends around the entire inner circumference. This groove 16 is arranged to engage bars 67 of the first operational element 50 in order to prevent movement of the first operational element 50 along the engagement axis E when the first operational element 50 is inserted into the housing 4.

The second chamber 11 is arranged to accommodate the second operational element 80. In the inner surface of the second chamber is formed a protrusion 9 which mates with a corresponding groove 86 in the side of the second operational element 80, in order to prevent rotational and axial movement of the second operational element 80. The second chamber 11 is not of constant diameter, but rather has a taper section 14 of decreasing diameter in the direction of the third chamber 12. It is against this taper section 14 that the prongs 140 of the cam body 100 bear to act as spring elements when the cam body 100 is pushed further into the housing 4.

A guide ring 27 is arranged in the second chamber 11, which is flanked either side by a first sealing ring 25 and a second sealing ring 26. These serve to provide an effective seal between the spigot S and the housing 4.

The third chamber 12 is arranged to receive an end of an inserted conduit K, preferably such that the conduit is sealing within the third chamber 12.

The fourth chamber 13 is arranged to receive a flow of media from the end of the inserted conduit K. The housing 4 features a fir-tree profile 17 on its outer surface 5 in the region of the fourth chamber 14 for the purpose of conduit a further conduit or for connecting the line connector 1 into a further opening.

A further protrusion 9 is formed on the outside of the housing arranged to match with catch elements 168 of the safety latch (not shown) to hinder the safety latch 160 from being pulled off from the line connector 1. The housing 4 also comprises a first opening 19 and a (blind) second opening 20, which mate with protrusions 162 of the safety latch 160 (not shown).

A safety opening 18 is formed in a wall of the first chamber 10 of the housing 4, into which a safety pin 161 of a safety latch 160 (not shown) is arranged to protrude in an engaged position of the safety latch 160.

The manner of functioning and use of a particular embodiment of the line connector will now be described.

### Assembly of the Line Connector

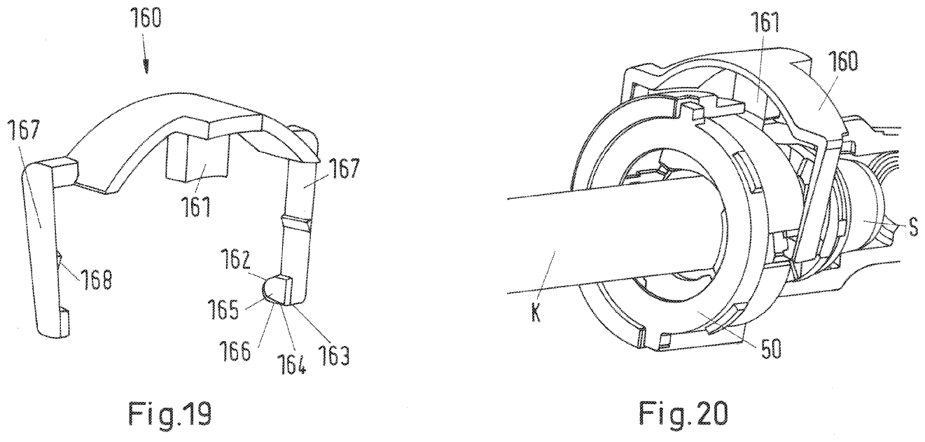

FIGS. 1a and 1b, FIGS. 13a to 18 and FIGS. 20 to 22 show various views of the line connector in different positions and states of assembly and use. FIG. 19 shows a view of the safety latch.

First, the second operational element 80 will be fixed into the second chamber 11 of the housing 4, for instance by means of a snap-in connection (it being noted that in some cases the second operational element 80 may already be a part of the housing 4). Then, the cam body 100 may be either placed into the first chamber 10 of the housing 4 and the first operational element 50 thereafter fixed in the housing 4, or the cam body 100 and the first operational element 50 may be held together and then inserted into the first chamber 10 of the housing 4 in one motion. Either way, the first operational element 50 is inserted so that the feet 64 are aligned with the notches 15 in the front surface 7 of the housing 4 and so that the bars 67 snap into the groove 16 on the inner surface 6 of the first chamber 10, so that the first operational element 50 is secured against rotational and translational motion.

The line connector 1 is now ready to receive a conduit K. However, typically, the line connector 1 will be attached beforehand to an attachment point or another conduit at its outlet 3. For this, the relevant part will be slid over the fir-tree profile 17 on the outer surface 5 of the housing 4.

### Conduit Insertion

A conduit 5 is provided having an appropriate part for cooperation with the attachment mechanism 149, in the present case a circumferential collar 201 positioned a certain distance from the conduit end.

The end of the conduit K is first inserted through the central opening 58 of the first operational element 50 and the central opening 130 of the cam body 100 and further into the housing 4 until the circumferential collar 201 abuts against the front side 102, i.e. the legs 106, of the cam body 100. The user will then experience a resistance to further insertion.

At this point, the user pushes the conduit K with a slightly increased force. This causes the collar 201 to bear against the front inclined regions 119 of the legs 106, causing the legs to be pushed radially outwards as the conduit K is inserted further. At a certain point, the legs 106, in particular the hook parts 113, will have been displaced far enough to allow the collar 201 to pass through into the attachment region 114 of the attachment mechanism 149. The conduit K is now attached to the cam body 100 via the attachment mechanism 149, so that the cam body 100 is substantially fixed to the conduit K relative to translational movement. However, the cam body 100 is still able to rotate about the conduit K.

### Operation of the Unlocking and Locking Mechanism

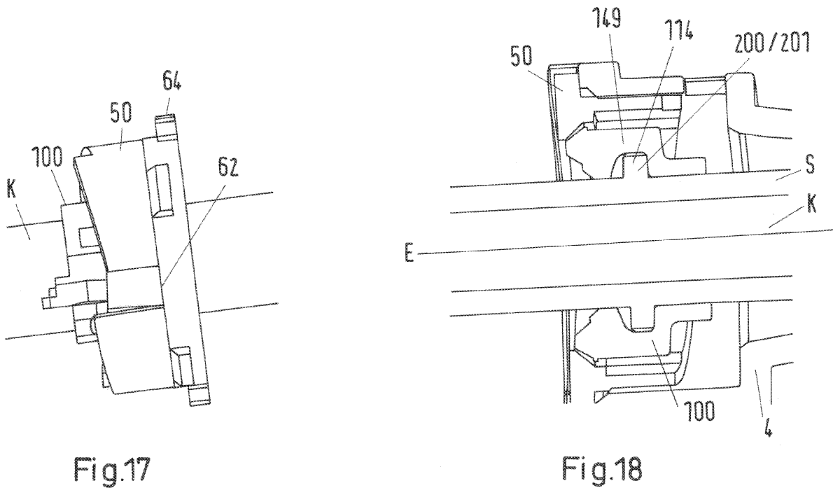

Reference is made initially to FIGS. 17 and 18 where the line connector 1 is in a locking state, i.e. where the cam body 100 is in a locking position. As can be seen from FIG. 18, the hook parts 113 of the legs 106 are situated in close proximity to the collar 201 of the conduit K. In the locking position, if a user goes to pull the conduit K to remove it, he will find that he is unable to do so, because the legs 106 are prevented from being radially displaced by the flange 71 of the first operational element 50. Further, the cam body 100 is also unable to be removed from the housing due to the protrusions 122 extending past the foundation 105 in the radial direction.

As can be seen with reference to FIG. 17, in the locking position, the cam body 100 is positioned so that protrusions 122 are located in the slots 62 of the first operational element 50.

When a user desires to unlock the line connector 1 so that he is able to remove the conduit K, he undertakes the procedure described as follows.

Firstly, the conduit K is pushed inwards i.e. further into the housing. The movement of the conduit K, specifically, of the collar 201, carries the cam body 100 inwards. At a certain point, the cam body 100 will have been moved far enough that the prongs 140 bear against the second operational element 80, in particular against the second engagement profile 87 thereof. Since the second engagement profile 87 comprises second sloping regions 88, further linear motion of the cam body 100 will be accompanied by rotational motion thereof, since the cam body 100 is free to rotate around the conduit K.

After a certain degree of rotational motion, the head parts 143 of the prongs 140 will come to bear against the stops 89 formed in the second engagement profile 87, which means that further rotational motion of the cam body 100 is hindered.

Next, the user pulls on the conduit K. This carries the cam body 100 back along the engagement axis E in the direction opposite to the insertion direction of the conduit. In this way, the radially extending protrusions 122 of the cam body 100 will come to bear against the first engagement profile 59 of the first operational element 50, in particular against first sloping regions 60. This is due to the configuration of the first operational element 50 relative to the second operational element 80, whereby the first and second sloping regions 60, 88 are arranged such that it is always possible for either the prong 140 or the protrusion 122 to bear against a first or second sloping region 60, 88 to cause rotational motion of the cam body 100.

Thus, in pulling the conduit K in the outwards direction and causing the cam body 100 to engage with the first operational element 50, the cam body 100 is rotated further. Eventually, the cam body 100 is rotated far enough that the protrusion 122 comes to bear against a stop 61 in the first engagement profile 59, which prevents further rotational motion. This is the unlocking position.

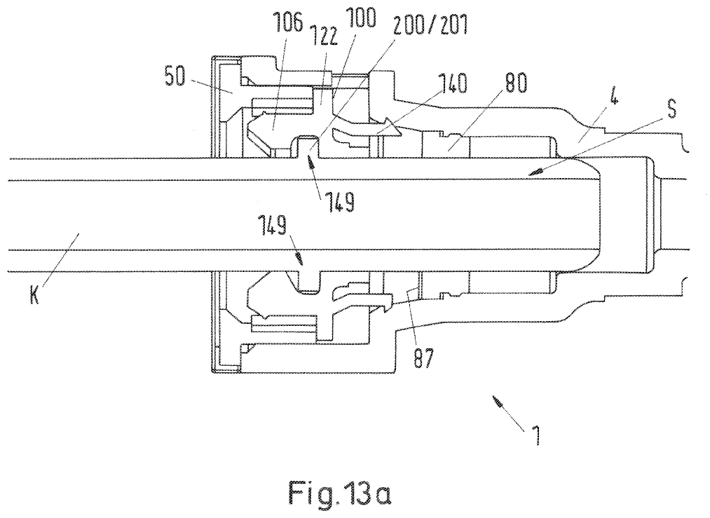

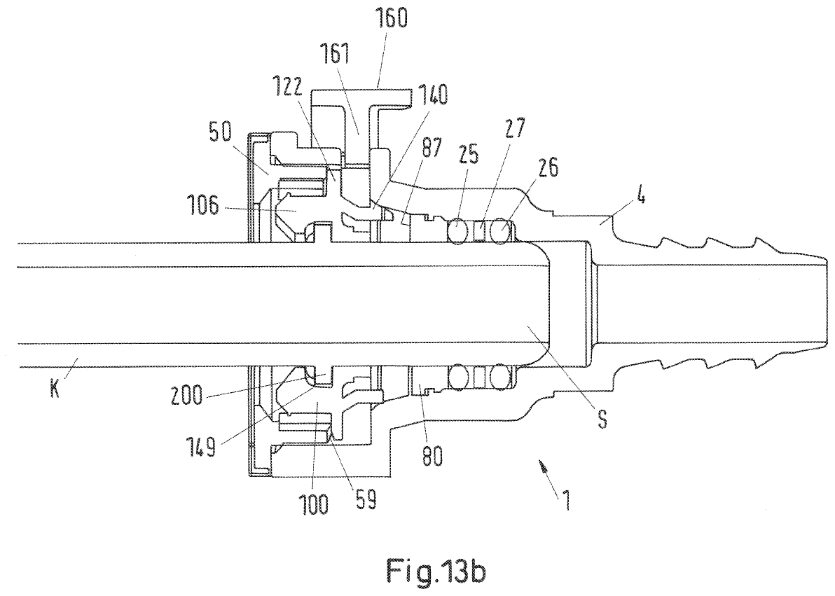

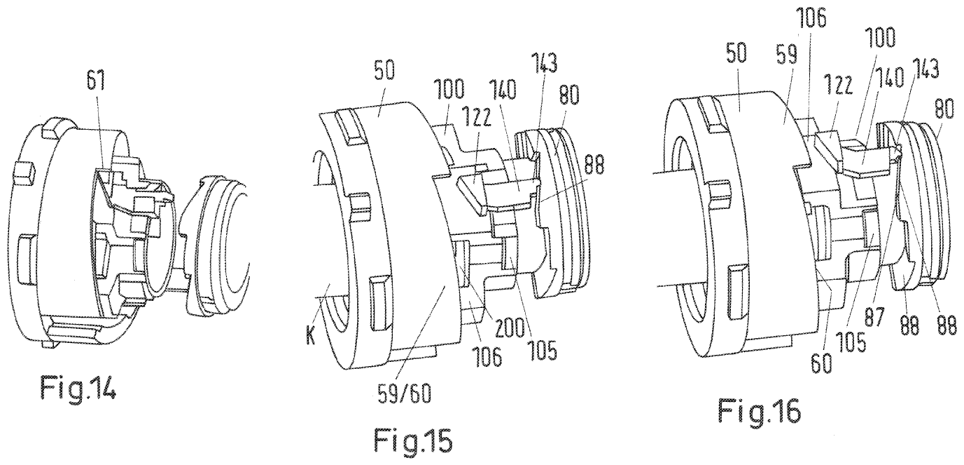

The unlocking position is shown in more detail in FIGS. 13a, 13b and 14.

In order to remove the conduit K from the line connector 1 in the unlocking position, the user exerts a pulling force on the conduit K. This causes the collar 201 to bear against inner inclined regions 120 of the legs 106. As the user increases the pulling force, the legs 106 will be displaced outwards. In contrast to the locking position, here, there is sufficient space for the legs 106 to be displaced, in particular the hook parts 113. This space is achieved by the presence of inner recesses 70 in the walls 51 of the first operational element 50.

The detachment process is further encouraged but the abuttal of the protrusions 122 of the cam body 100 against the first engagement profile 59. Here, a reactionary force, resulting from the pulling of the conduit K and thereby the cam body 100, is exerted on the protrusions 122. This enables the protrusions 122 to act as a kind of lever to produce a leverage on the legs 106, causing them to flex outwards and open the attachment mechanism 149. This also prevents the cam body 100 from being pulled further out of the housing 4, thereby allowing the conduit K to freely exit the attachment region 114 and thereby the line connector 1.

It may therefore be seen how it is possible to lock and unlock the line connector 1 solely by means of application of a force along the engagement axis E, which can be done with only one hand.

### Operation of the Safety Latch

FIGS. 19 to 22 illustrate the safety latch and its disengaged position. A further aspect of the disclosure is the safety latch 160, which can be used to prevent the cam body 100 from being moved out of a locking position. Broadly speaking, the function of the safety latch 160 is to protrude into the housing 4 in such a manner that the cam body 100 cannot be moved out of the locking position. This is achieved in the following manner.

The housing 4 comprises a safety opening 18 positioned such that when the cam body 100 is in the locking position, the safety opening 18 is radially above a leg 106 of the cam body 100 but displaced in the inward direction. In particular, the safety opening 18 is configured and located such that a safety pin 161 of a safety latch 160 can be inserted into the safety opening 18 so that the safety pin 161 is directly behind the cam body 100, preferably behind a leg 106 of the cam body 100, when the cam body 100 is in the locking position. In this way, the safety pin 161 can be inserted through the safety opening 18 after the cam body 100 reaches the locking position, whereafter it will no longer be possible to bring the cam body 100 out of the locking position without first removing the safety pin 161 from the safety opening 18. It is thereby not possible to remove the conduit K without first removing the safety latch 160.

The line connector 1 is further configured such that the safety latch 160 can only be moved out of a disengaged position when the cam body 100 is in the locking position.

The line connector 1 is configured such that in the locking position, the cam body 100 is situated further within the first operational element 50, e.g. along the engagement axis E, since the flange 71, which contributes to preventing the attachment mechanism 149 from opening, is arranged in the region of the base 53 of the first operational element 50. For this reason, the slots 62 extend alone the entire axial length of the walls 51 to the base 53 of the first operational element 50, which gives the protrusions 122 and thereby the cam body 100 sufficient space to move axially into the first operational element 50.

The housing 4 is configured for instance through the positioning of the housing notches 15 to have a radial first opening 19 aligned with each slot 62 of the first operational element 50, when the latter is inserted into the housing 4. A second opening 20 is provided beneath each first opening 19 in the direction of engagement of the safety latch 160. Each opening 19, 20 has the form of a square or rectangle, and thus has four walls: a bottom wall 21 furthest from the safety opening 18, a top wall 22 nearest to the safety opening, a left wall 23 closest to the insertion opening 8 of the housing 4, and a right wall 24 furthest from the insertion opening 8 of the housing 4. The openings 19, 20 are aligned such that their bottom walls 21 are perpendicular to the direction of engagement of the safety latch 160.

The safety latch 160 has protrusions 162 which are configured to extend into the openings 19, 20. In particular, the safety latch 160 has two legs 167, whereby each leg 167 has an inward protrusion 162 at its end. Each leg 167 further comprises a catch element 168 situated on the same side as the respective protrusion 162 that is, on the inner side).

In a disengaged position, the safety latch 160 is oriented such that the safety pin 161 does not protrude through the safety opening 18 but the leg protrusions 162 do extend into the first openings 19 of the housing 4.

In an engaged position, the safety latch 160 is displaced downward, i.e. closer to the housing 4, such that the safety pin 161 protrudes through the safety opening 18 and into the housing 18, and such that the leg protrusions 162 extend into the second openings 20 of the housing 4 and further so that the catch elements 168 of the safety latch 160 bear against a wall of the first openings 19 to secure the safety latch 160 against disengagement.

The protrusions 162 of the safety latch 160 have a particular form. They comprise a base 163 and a head 164, whereby the base 163 has the form of a cuboid and is joined to the leg 167, and the head 164 has a first inclined region 165 and a second inclined region 166, and is joined to the base 163. The first inclined region 165 is arranged to face the right walls 24 of the openings 19, 20 when the safety latch 160 is in the disengaged or engaged position, and the second inclined region 166 is arranged to face the bottom walls 21 of the openings 19, 20 when the safety latch 160 is in the disengaged or engaged position. The first and second inclined regions 165, 166 therefore face in perpendicular directions. The base 163 of the protrusions 162, in particular a bottom wall of the base 163, is arranged to contact a bottom wall 21 of the openings 19, 20 when the safety latch 160 is in the disengaged or engaged position.

Now will be explained in further detail how the safety latch 160 is brought from a disengaged position into an engaged position.

In the unlocking position where the safety latch 160 is disengaged, the protrusions 162 extend all the way into the first openings 19. In this case, it is only the base 163 of the protrusions 162 which bear against the bottom walls 21 of the first openings 19, since the heads 162 of the protrusions 162 extend all the way into the inside of the housing 4. Thus, when a user pushes down on the safety latch 160, he is unable to engage it because the flat walls of the cuboid-shaped base 163 of the protrusions 162 abut against the bottoms walls 21 of the first openings 19.

This situation changes when the line connector 1 enters a locking position, i.e. when the user actuates the conduit K to move the cam body 100. Through rotation of the cam body 100, the protrusions 122 of the cam body 100 move along the first engagement profile 59 to reach the slot 62. However, as the protrusions 122 enter the slot 62, they encounter the protrusions 162 of the safety latch 160, in particular the heads 164, which extend into the housing 4 and thereby into the slot 62 of the first operational element 50.

However, when the user pulls further on the conduit K, this causes the cam body 100 to move further into the first operational element 50, which causes the protrusions 122 of the cam body 100 to bear against the first inclined regions 165 the safety latch 160, which are inserted into the housing 4. Thereby, the protrusions 162 of the safety latch 160 are pushed back out of the first openings 19 a small amount, i.e. by an amount corresponding to the extent of the protrusions 122 of the cam body 100.

This is sufficient to cause the second inclined regions 166 of the head 164—and no longer the wall of the base 163—to bear against the bottom walls 21 of the first openings 19.

Now, when a user pushes down on the safety latch 160, the second inclined regions 166 will bear against the bottom walls 21, which causes the protrusions 162 of the safety latch 160 to be displaced entirely out of the first openings 19. As a user pushes further, the safety latch 160 will continue to move into the engagement position, since there is now nothing to hinder its movement.

In this way, the safety latch 160 enters the engagement position and the safety pin 161 enters the safety opening 18. In this case, a user is unable to push the conduit K into the line connector 1 to cause the cam body 100 to reach the unlocking position.

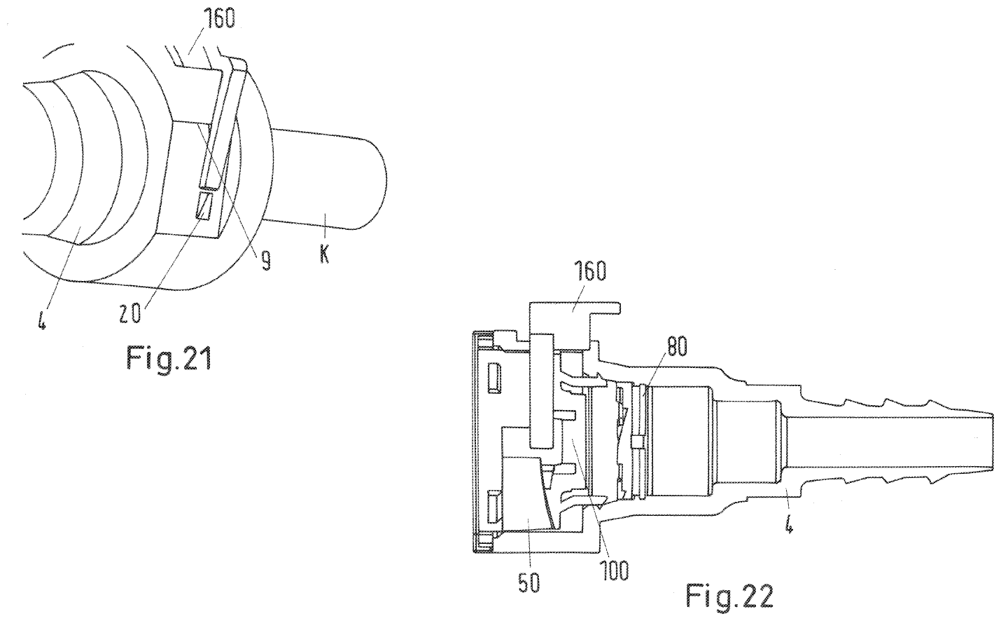

To disengage the safety latch 160, a user pulls it upwards. This causes protrusions 162 to bear against inclined regions of a blind second opening 20 in the housing 4. This displaces the protrusions 162 and thereby the legs 167 out of the second opening 20, enabling the user to pull the safety latch 160 out of the engaged position and back into the disengaged position. The safety latch 160 is prevented from being pulled completely away from the housing by catch elements 168, which are arranged to bear against a protrusion 9 arranged on the housing 4, as illustrated in FIG. 21.

The invention is not restricted to any one of the previously described embodiments, but rather may be varied in any manner of ways. All features and advantages arising from the claims, description and the figures, including constructional aspects, spatial arrangements and method steps, may play a part in the invention both alone and in combinations with other features.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCES

| | |
|---|---|
| Line connector | 1 |
| Inlet | 2 |
| Outlet | 3 |
| Housing | 4 |
| Outer surface | 5 |
| Inner surface | 6 |
| Front surface | 7 |
| Insertion opening | 8 |
| Protrusion | 9 |
| First chamber | 10 |
| Second chamber | 11 |
| Third chamber | 12 |
| Fourth chamber | 13 |
| Taper section | 14 |
| Notch | 15 |
| Groove | 16 |
| Fir tree profile | 17 |
| Safety opening | 18 |
| First opening | 19 |
| Second opening | 20 |
| Bottom wall | 21 |
| Top wall | 22 |
| Left wall | 23 |
| Right wall | 24 |
| First sealing ring | 25 |
| Second sealing ring | 26 |
| Guide ring | 27 |
| Engagement mechanism | 30 |
| Engagement axis | E |
| Conversion mechanism | 40 |
| First operational element | 50 |
| Wall | 51 |
| End | 52 |
| Base | 53 |
| Outer side | 54 |
| Inner side | 55 |
| Bottom side | 56 |
| Top side | 57 |
| Central opening | 58 |
| First engagement profile | 59 |
| First sloping region | 60 |
| Stop | 61 |
| Slot | 62 |
| Side | 63 |
| Foot | 64 |
| Bottom face | 65 |
| Edge | 66 |
| Bar | 67 |
| Front side | 68 |
| Rear side | 69 |
| Inner recess | 70 |
| Flange | 71 |
| Central axis | C1 |
| Circumferential direction | L |
| Second operational element | 80 |
| Inner side | 81 |
| Outer side | 82 |
| Top side | 83 |
| Bottom side | 84 |
| Central opening | 85 |
| Groove | 86 |
| Second engagement profile | 87 |
| Second sloping region | 88 |
| Stop | 89 |
| Step region | 90 |
| Central axis | C2 |
| Anticlockwise direction | R |
| Radial direction | D2 |
| Circumferential direction | M |
| Cam body | 100 |
| Back side | 101 |
| Front side | 102 |
| Outer side | 103 |
| Inner side | 104 |
| Foundation | 105 |
| Leg | 106 |
| First leg | 107 |
| Second leg | 108 |
| Third leg | 109 |
| Fourth leg | 110 |
| Joining piece | 111 |
| Radially extending part | 112 |
| Hook part | 113 |
| Attachment region | 114 |
| Top inclined region | 115 |
| Recess | 116 |
| Throat | 117 |
| Bend | 118 |
| Front inclined region | 119 |
| Inner inclined region | 120 |
| Top face | 121 |
| Protrusion | 122 |
| First protrusion | 123 |
| Second protrusion | 124 |
| Cross-section | 125 |
| Hypotenuse | 126 |
| Base | 127 |
| Side | 128 |
| Rear edge | 129 |
| Central opening | 130 |
| Lip | 131 |
| Interface | 132 |
| Internal side | 133 |
| Flank | 139 |
| Prong | 140 |
| Tail part | 141 |
| Body part | 142 |
| Head part | 143 |
| First finger | 144 |
| Second finger | 145 |
| First pointed portion | 146 |
| Second pointed portion | 147 |
| Rear wall | 148 |
| Attachment mechanism | 149 |
| Straight line | AB |
| Width | W |
| Central axis | C3 |
| Safety latch | 160 |
| Safety pin | 161 |
| Protrusion | 162 |
| Base | 163 |
| Head | 164 |
| First inclined region | 165 |
| Second inclined region | 166 |
| Leg | 167 |
| Catch element | 168 |
| Conduit | K |
| Spigot | S |
| Protrusion | 200 |
| Collar | 201 |

1. A line connector having a housing with an inlet for a spigot (S) of a conduit (K) and an outlet, the line connector having an engagement mechanism for releasably holding the spigot (S) in an inserted position, the engagement mechanism surrounding an engagement axis (E) and wherein the engagement mechanism comprises:
a conversion mechanism, and
a cam body configured to be moveable relative to the conversion mechanism along and around the engagement axis (E) and comprising an attachment mechanism for the conduit (K),
whereby the conversion mechanism and the cam body are configured such that through engagement of the cam body with the conversion mechanism, motion of the cam body along the engagement axis (E) is converted into rotational motion of the cam body around the engagement axis (E),
whereby the conversion mechanism is further configured so as to allow the cam body to occupy, at different rotational positions of the cam body, an unlocking position in which the attachment mechanism can be unlocked for releasing the spigot (S) from the line connector, and a locking position in which the attachment mechanism is locked.

2. The line connector of claim 1, wherein the conversion mechanism comprises a first operational element and a second operational element which may be fixed relative to movement along and around the engagement axis (E), and
whereby the cam body is arranged to be moveable along and around the engagement axis (E) between the first operational element and the second operational element.

3. The line connector of claim 2, wherein the second operational element and the cam body are configured such that through engagement of the cam body with the second operational element, linear motion of the cam body along the engagement axis (E) is converted into rotational motion of the cam body (E) around the engagement axis (E),
whereby the first operational element is configured so as to allow the cam body to occupy, at different rotational positions of the cam body, an unlocking position in which the attachment mechanism can be unlocked, and a locking position in which the attachment mechanism is locked.

4. The line connector of claim 2, wherein the first operational element and the cam body are configured such that through engagement of the cam body with the first operational element, linear motion of the cam body along the engagement axis (E) is converted to rotational motion of the cam body around the engagement axis (E).

5. The line connector of claim 1, wherein the unlocking and locking positions respectively comprise a protracted position and a retracted position of the cam body along the engagement axis (E).

6. The line connector of claim 1, wherein the line connector is configured such that in the unlocking position, the attachment mechanism can be opened through application of a force to the cam body along the engagement axis (E).

7. The line connector of claim 6, wherein the force applied to the cam body along the engagement axis (E) is in a removal direction of an inserted spigot (S).

8. The line connector of claim 2, wherein the attachment mechanism can be opened by forcing the cam body and the first operational element together, whereby the first operational element is arranged further towards an insertion opening for the spigot (S) than the second operational element.

9. The line connector of claim 2, wherein in the locking position, the attachment mechanism is prevented from opening by a cooperation between the cam body and the first operational element, whereby the first operational element is arranged further towards an insertion opening for the spigot (S) than the second operational element.

10. The line connector of claim 1, wherein the attachment mechanism comprises at least one hook part.

11. The line connector of claim 10, wherein the line connector is configured such that the attachment mechanism can be opened through movement of the at least one hook part.

12. The line connector of claim 11, wherein movement of the at least one hook part is in the radially outward direction.

13. The line connector of claim 10, wherein the line connector is configured to hinder movement, in particular radially outward movement, of the at least one hook part in the locking position.

14. The line connector of claim 10, wherein the first operational element comprises a space into which the at least one hook part may be displaced in the unlocking position.

15. The line connector of claim 10, wherein the at least one hook part comprises at least one inclined region.

16. The line connector of claim 1, wherein the cam body comprises at least one inclined region configured and located so that a protrusion on an outer surface of an inserted spigot (S) may bear against the at least one inclined region when the spigot (S) is removed from the line connector.

17. The line connector of claim 1, wherein the cam body comprises at least one inclined region configured and located so that a protrusion on an outer surface of the spigot (S) to be inserted may bear against the at least one inclined region when the spigot (S) is inserted into the line connector.

18. The line connector of claim 1, wherein the cam body comprises an abutment for actuating the attachment mechanism and configured to bear against a first operational element when the cam body is forced against the first operational element.
